(19) United States
(12) Patent Application Publication
(10) Pub. No.: US 2024/0150189 A1
(43) Pub. Date: May 9, 2024

(54) METHODS AND SYSTEMS FOR EFFICIENTLY AND CLEANLY MANUFACTURING AMMONIA, AMMONIUM SULFATE, NITRIC ACID, AMMONIUM NITRATE, OR COMBINATIONS THEREOF FROM COAL AND PETCOKE PRODUCTS

(71) Applicant: Decarbtek Global Corp., Stirling (CA)

(72) Inventors: Henry Gil, Calgary (CA); Andrew Squires, Stirling (CA)

(21) Appl. No.: 18/488,388

(22) Filed: Oct. 17, 2023

Related U.S. Application Data
(60) Provisional application No. 63/416,848, filed on Oct. 17, 2022.

(51) Int. Cl. C01C 1/04; C01B 3/02; C01B 3/56; C01B 17/50; C01C 1/24; C10J 3/48; C10K 1/00; C10K 3/04

(52) U.S. Cl. CPC C01C 1/0488; C01B 3/025; C01B 3/56; C01B 17/503; C01C 1/0405; C01C 1/0452; C01C 1/24; C10J 3/48; C10K 1/004; C10K 1/005; C10K 3/04; C01B 2203/043; C01B 2203/046; C01B 2203/0475; C01B 2203/0485; C01B 2203/06; C01B 2203/068; C01B 2203/84; C10J 2300/0926; C10J 2300/093; C10J 2300/0943; C10J 2300/0983; C10J 2300/1643; C10J 2300/1656

(57) ABSTRACT

The disclosure relates generally to methods and systems for manufacturing ammonia, ammonium sulfate, nitric acid, ammonium nitrate, or combinations thereof, and particularly to clean and efficient methods and system configurations for manufacturing ammonia, ammonium sulfate, nitric acid, ammonium nitrate, or combinations thereof using coal, petcoke, asphaltenes and/or hydrocarbon waste products.

### CROSS REFERENCE TO RELATED APPLICATION

The present application claims the benefits of U.S. Provisional Application Ser. No. 63/416,848, filed Oct. 17, 2022, entitled “CONCEPT FOR HIGH EFFICIENCY ULTRA-LOW EMISSIONS CLEAN BLUE COAL-PETCOKE-WASTE PRODUCTS METHOD TO MANUFACTURE AMMONIA, AMMONIUM SULFATE, NITRIC ACID AND AMMONIUM NITRATE WITH NEAR-ZERO CARBON AND SULFUR EMISSIONS”, which is incorporated herein by this reference in its entirety.

### FIELD

The disclosure relates generally to methods as well as configurations for manufacturing ammonia, ammonium sulfate, nitric acid, ammonium nitrate, or combinations thereof, and particularly to clean and efficient methods and system configurations for manufacturing ammonia, ammonium sulfate, nitric acid, ammonium nitrate, or combinations thereof using coal, petcoke, asphaltenes and/or hydrocarbon waste products.

### BACKGROUND

The petrochemical industry relies on hydrogen, nitrogen, and oxygen gases for many of its processes to manufacture certain known commodities like polymers, ammonia, olefins, and other chemicals. Similarly, with the global energy transition into low carbon fuels and low carbon energy, oxygen manufacture plays an important role in oxy-combustion and pre-combustion carbon dioxide (CO₂) capture, particularly with power generation, fertilizer, and chemical production. Additionally, ammonia (NH₃) is presently being explored and tested as an alternative fuel and as a safe means to store and transport, hydrogen, as ammonia does not require the cryogenic storage temperatures of −280° C. that hydrogen (H₂) does. Ammonia liquid, like propane is in a liquid state at −35° C. and can be stored and transported in liquid form in atmospheric cryogenic tanks or at 300 psig pressurized vessels at ambient temperatures.

Hydrogen can be manufactured from coal, petroleum coke (petcoke), natural gas or renewable biomass utilizing solids gasification, auto-thermal reforming, steam methane reforming, biomass pyrolysis, or plasma gasification, yielding syngas comprising hydrogen (H₂), hydrogen sulfide (H₂S), carbonyl sulfide (COS), carbon monoxide (CO), carbon dioxide (CO₂), and other gases. Nitrogen oxides (NOₓ), suflur oxides (SOₓ), and carbon oxides (COₓ) have long been linked to contributing to acid rain as well as climate change, resulting in global warming and global weather extremes and causing significant damages to infrastructure around the world. Governments in a collaborative manner have worked together to reduce sulfur oxide, carbon oxide, and nitrogen oxide emissions and to capture and sequester carbon and sulfur efficiently to limit their effects on the planet.

Society has relied heavily on fossil fuels since the 1900's, in particular coal and petroleum, and the world has reached a critical stage where the need to limit the use of these energy fuels is required to maintain quality of life. Over the next few years, a transition into low carbon fuels and eventually fully transitioning into renewables seems to be the global trend; however, this may lead to a time intensive and costly processes to develop and make such processes commercially viable and available.

Additionally, emission capture technologies and methods are a developing and evolving science with significant research being conducted on a global basis in efforts to abate climate change and reduce industrial emissions. Decarbonation and desulfurization of fuels to a hydrogen economy and chemical fertilizers such as ammonia provides society with a means of continuing to utilize the traditional fuels such as coal and pet-coke as fuel in an ultra clean and responsible manner and to continue to expand cost effective food production yields through nitrogen fertilizers such as ammonia, ammonium sulfate, ammonia nitrates and other ammonia derivatives or feedstocks such as nitric acid for industrial usages. After transport fuels, power generation, and concrete manufacturing, fertilizers are one of the lead contributors to carbon dioxide emissions. Additionally, the manufacturing of hydrogen and hydrogen derivatives primarily utilizing natural gas with steam methane-based technologies that utilize air for combustion and processing, make it difficult to efficiently capture carbon dioxide for sequestration because of the large amounts of nitrogen present.

Compared to natural gas and oil, coal is a highly abundant and inexpensive energy resource. Coal has powered the industrialization of many nations over history and continues to do so today. It is one of the big players in today's energy system, providing about 50% of the world's electricity. Coal, compared to nuclear energy, is a much safer energy proposition and also has valuable metals, particularly rare-earth metals, that can be efficiently exploited in technological industry. Compared to oil, coal is a solid energy with less potential for undesirable events. Hydroelectric also has its challenges requiring the flooding of large areas of valuable land to be displaced. Most often coal is found near the earth's surface, suggesting the exploitation of this valued resource is very cost effective compared to other forms of energy.

The major concern with coal, however, is the carbon and emission intensity as it is largely made-up of carbon, sulfur, and heavy metals. There is therefore a need for sustainable methods and systems that effectively utilizes coal and/or related fuels for the manufacture of key compounds, such as ammonia, with limited or no emissions.

### SUMMARY

These and other needs are addressed by the various aspects, embodiments, and configurations of the present disclosure.

The present disclosure provides clean and efficient methods and system configurations for manufacturing ammonia, ammonium sulfate, nitric acid, ammonium nitrate, or combinations thereof using coal, petcoke, asphaltenes and/or hydrocarbon waste products. In some embodiments, sulfur dioxide and carbon dioxide are captured utilizing carbon-free hydrogen as a fuel for power generation and feedstock for ammonia synthesis. The process also provides the usage of a cryogenic air separation unit (ASU) fluid stream (e.g., N₂) as a refrigerant for ammonia synthesis liquefaction and as a cryogenic carbon capture process. Other methods of manufacturing hydrogen using natural gas are air based SMR (Steam Methane Reformer), POX (Partial Oxidation Reformers), gasification, plasma arc, pyrolysis, thermal degradation of coal, petroleum coke, methane, or other fossil commodities.

The processes disclosed herein bridge the gap for producing clean hydrogen fuel from dirty coal and pet-coke in power generation and desulfurizes and decarbonizes ammonia for industrial use, such as a fertilizer or as a fuel, thus reducing the complexity and capex associated with power generation and ammonia manufacturing and assisting in the transition from blue hydrogen to green hydrogen from fossil fuels and other renewable processes. The process disclosed herein captures sulfur species at a very high recovery efficiency and abates nitrogen oxides to ultra-low near-zero (e.g., about zero) levels well below regulations.

In embodiments, the methods and systems disclosed herein capture hydrogen sulfide (H₂S), carbonyl sulfide (COS), and carbon dioxide (CO₂) from a syngas stream utilizing coal and pet-coke oxy-gasification processes. The methods and processed may utilize a sour water gas shift reaction to convert carbon monoxide into a highly concentrated carbon dioxide stream where carbonyl sulfide, through hydrolysis, is transformed to hydrogen sulfide, and the hydrogen sulfide and carbon dioxide are separated and captured with a methanol solvent process. The combustion of hydrogen sulfide converts hydrogen sulfide to sulfur dioxide (SO₂) which is captured by adding value to the sulfur to manufacture ammonium sulfate, an excellent and well proven canola, and grains fertilizer.

Rather than incinerate tail gases as conventionally done, the present disclosure utilizes a vapour recovery system to recycle process tail gases back into the process to be used as hydrogen and for the capture of unwanted air emissions, improving overall efficiencies in energy and overall pollutants and carbon capture. A pressure swing adsorption may clean the hydrogen to high purity levels (e.g., greater than 90%, greater than 95%, greater than 99%, greater than about 99.9999%) and the PSA regenerative gases may be processed at cryogenic temperatures further capturing 10% to 15% carbon dioxide slip that was not captured by the methanol solvent process. Therefore, further polishing to capture the produced carbon dioxide for sequestration and/or enhanced oil recovery into a subsurface reservoir where it will be disposed and stored in a safe manner can be achieved.

The present disclosure adds value to coal and pet-coke by desulfurizing and decarbonating coal into a clean feed and returning (e.g., sequestering) the carbon dioxide and sulfur back into the earth where it originally came while utilizing the hydrogen for the future hydrogen economy and/or for the manufacture of ammonia for food production and/or petrochemical usage.

Refrigeration integration cycles that reduce capex and operating costs and additionally the ammonia-water cycle may be utilized herein to provide for low grade waste heat recovery for power generation or process cooling, significantly reducing the cooling water requirements where it makes economic sense. High energy steam generation from the exothermic nature of the overall integration is integrated to maximize energy utilization and efficiency for combined heat and power.

Refrigerants and refrigeration cycles may be used herein to separate, through liquefaction, the necessary molecular building block elements for further petrochemical processing. The integration of the hydrogen, oxygen and nitrogen manufacturing processes rely on each-other's manufactured products to produce a commodity product for sale. The processes of the present disclosure may be self-generating inside the boundary limits of respective processes to provide the elements across inter plant boundary limits such as, nitrogen, oxygen, hydrogen, carbon dioxide, hydrogen sulfide, ammonia, nitric acid, ammonium sulfate, ammonia nitrates, etc.

Integrating processes with an ASU and utilizing the ASU's liquefaction as a liquid refrigerant allows for the use of that refrigerant to separate carbon dioxide into dense phase carbon dioxide and hydrogen gas. Similarly, with petrochemicals and chemicals such as ammonia gases, the liquid air, primarily nitrogen from the ASU can be utilized as a refrigerant liquefaction cycle to condense these gaseous streams. Accordingly, significant cost savings and avoiding the need for the process licensor to supply their own refrigeration processes inside their respective plant boundary limits may be achieved. Integration of the processes disclosed herein may require a higher energy duty for the ASU liquefaction of air; however, the integration provides for less equipment costs and synergies associated with economies of scale with respect to refrigeration. Another refrigeration cycle for consideration is the ammonia water cycle, which is not a compression-based refrigeration cycle and relies on the properties of anhydrous ammonia and aqueous ammonia to expand ammonia gas through a turbogenerator for low grade energy power generation or for process cooling. The ammonia water cycle presented herein may particularly be used in geographic locations where cooling water is at a premium and needs to be conserved for drought reasons, for example.

Refrigeration cycles such as water-ammonia refrigeration and other known refrigeration cycles can be utilized. However, the present disclosure particularly covers such refrigeration cycles to capture carbon cryogenically. Such cryogenic processes are simple, cost effective and do not require a large footprint compared to traditional methods. The pressure swing adsorption (PSA) in combination with steam compression and syngas drying facilitates separation of carbon dioxide and hydrogen effectively without producing solid carbon dioxide, as the hydrogen separates easily and as the carbon dioxide is concentrated by the PSA. It provides for high efficiency recoveries beyond traditional methods with coal and pet-coke and even natural gas feeds. The PSA may yield a hydrogen purity of greater than about 90%, or greater than about 95%, or greater than about 99%, or greater than about 99.9%, or about 100% for ammonia synthesis and as a feed for other petrochemicals manufacture. A sulfur (Zn) guard may be installed as process insurance should there be a major process upset, however the guard may be viewed as redundancy and may not be needed at to achieve desired purity levels.

In embodiments of the present disclosure, methods and systems support: contacting coal, petcoke, or both with water to form a fuel slurry; contacting one or more surfactant polymers with water to form a surfactant slurry; mixing the fuel slurry and the surfactant slurry to form a fuel emulsion; and providing the fuel emulsion to a gasifier to produce a synthesis gas comprising carbon monoxide, carbon dioxide, and sulfur.

Depending on the coal energy value, the slurry may be formed by contacting 100% or about 50:50 coal:petcoke, 100% petcoke, or anywhere in between (e.g., 10:90, 20:80, 30:70, 40:60, 50:50, 60:40, 70:30, 80:20, 90:10 coal:petcoke). The addition of slop oils and asphaltenes and refinery residue will also impact the ratios. The amount or ration of added water is dependent on the emulsion requirements to suspend the solid materials. In some embodiments, the slurry may comprise between about 20% to 60% water, such as about 35% water. The water may eventually be quenched, separated and recycled into the emulsion at treatment.

The methods and systems further support mixing the fuel slurry and the surfactant slurry with waste residues to form the fuel emulsion, the waste residues comprising slop refinery residue, asphaltenes, biomass, other high calorific value waste products, or a combination thereof.

The methods and systems further support converting the carbon monoxide in the synthesis gas to hydrogen and additional carbon dioxide, forming a shifted synthesis gas.

The methods and systems further support removing at least a portion of the carbon dioxide and hydrogen sulfide in the shifted synthesis gas to form a cleaned synthesis gas, and capturing the carbon dioxide and hydrogen sulfide removed from the shifted synthesis gas.

The methods and systems further support removing remaining impurities from the cleaned synthesis gas to form hydrogen gas by inputting the cleaned synthesis gas to a pressure swing adsorption system, the impurities comprising noble gases, oxygen, nitrogen, carbon dioxide, carbon monoxide, or combinations thereof, and contacting the hydrogen gas with nitrogen to form a gas blend, wherein the gas blend comprises a 3:1 hydrogen to nitrogen ratio.

The methods and systems further support compressing the gas blend; passing the gas blend through one or more heat exchangers; and directing the gas blend from the one or more heat exchangers to an ammonia synthesis reactor to form ammonia from the gas blend.

The methods and systems further support producing ammonia sulfate, nitric acid, ammonium nitrate, or a combination thereof from the ammonia.

The methods and systems further support contacting the hydrogen sulfide removed from the shifted synthesis gas with molten sulfur to form sulfur dioxide; and contacting the sulfur dioxide and ammonia in an aqueous ammonia wash reactor to form ammonia sulfate.

In embodiments of the present disclosure, methods and systems support: removing impurities from a synthesis gas by inputting the synthesis gas into a pressure swing adsorber to form a substantially pure hydrogen gas, wherein the impurities comprise noble gases, oxygen, nitrogen, carbon dioxide, carbon monoxide, or combinations thereof; contacting the hydrogen gas with nitrogen to form a hydrogen and nitrogen gas blend, wherein the gas blend comprises a hydrogen to nitrogen, wherein the gas blend comprises a 3:1 hydrogen to nitrogen ratio; and producing ammonia from the gas blend.

The methods and systems further support utilizing a portion of the hydrogen gas for fuel.

The methods and systems further support removing hydrogen sulfide, or sulfur, or both, from the hydrogen gas by passing the hydrogen gas through a desulfurization bed, wherein the desulfurized hydrogen gas is contacted with the nitrogen to form the hydrogen and nitrogen gas blend.

The substantially pure hydrogen gas may comprise greater than about 90%, or about 95%, or about 99%, or about 99.99%, or about 99.999%, or near about 100% hydrogen.

In embodiments of the present disclosure, methods and systems support: contacting hydrogen sulfide gas with ionized molten sulfur in a combustor furnace to form sulfur dioxide; and contacting sulfur dioxide and aqueous ammonia in an aqueous ammonia wash reactor to form ammonia sulfate.

The methods and systems further support removing sulfur ash from the sulfur dioxide by passing the sulfur dioxide through a baghouse, wherein the sulfur-ash free sulfur dioxide is contacted with the aqueous ammonia in the absorber.

The ammonia sulfate is in a crystal form slurried with water, the methods and systems further support drying the ammonia sulfate crystals.

In embodiments of the present disclosure, methods and systems support: inputting water into a flooded tube chiller filled with liquid ammonia to form cooled water, wherein the liquid ammonia evaporates into an ammonia gas; generating a lower pressure ammonia by superheating the ammonia gas at a near constant pressure and expanding the ammonia gas through a turboexpander; contacting the lower pressure ammonia with water in an exothermic absorber to form an ammonia water mixture at pressure and temperature; pumping the ammonia water mixture from the exothermic absorber to form a higher pressure ammonia prior to entering into an ammonia regenerator, and inputting the higher pressure ammonia gas, output from the ammonia regenerator, through a turboexpander to form liquid ammonia for use in the flooded tube chiller.

The methods and systems further support utilizing the cooled water in a closed loop system to cool one or more system processes that require cooling.

Electric power is generated and recovered from the turboexpander.

A Joule Thomson (JT) valve is utilized for startup of the turboexpander.

Process waste heat is exchanged in the ammonia regenerator to boil off the ammonia from the ammonia-water mixture into a high pressure pure ammonia, without boiling the water and forming hot water, the hot water is recycled from the ammonia regenerator to the exothermic absorber.

The methods and systems further support inputting the high pressure ammonia gas from the ammonia regenerator to a rectifier to remove at least a portion of the water moisture in the high pressure ammonia gas; inputting the high pressure ammonia gas, output from the ammonia regenerator, to a molecular sieve dryer to remove all or a majority of the remaining water moisture saturated in the high pressure ammonia gas; and inputting the high pressure ammonia gas, output from the molecular sieve dryer, to a condenser to cool the high pressure ammonia gas prior to inputting the higher pressure ammonia gas through the turboexpander.

The high pressure ammonia gas exits the turboexpander as liquid ammonia at pressures and temperatures lower than the pressure and temperature requirements of the flooded tube chiller.

In embodiments of the present disclosure, methods and systems support: a feed preparation unit to form a fuel emulsion from a surfactant, coal, petcoke, hydrocarbon oil wastes, and water; a gasifier to form synthesis gas from the fuel emulsion; a pressure swing adsorber unit to remove impurities from the synthesis gas and form a hydrogen and nitrogen gas blend; an ammonia synthesis unit to synthesize ammonia from the hydrogen and nitrogen gas blend; a cryogenic system to cryogenically capture carbon dioxide from the pressure swing adsorber unit.

The methods and systems further support a water gas shift unit that receives the synthesis gas from the gasifier and converts carbon monoxide to hydrogen to form shifted synthesis gas.

The methods and systems further support a sour gas capture unit that receives the shifted synthesis gas from the water gas shift unit and captures carbon dioxide and hydrogen sulfide to form a cleaned synthesis gas, wherein the cleaned synthesis gas is input to the pressure swing adsorber unit.

The methods and systems further support an aqueous ammonia wash reactor, wherein sulfur dioxide is contacted with the ammonia to form ammonia sulfate.

The methods and systems further support a flooded tube chiller for cooling water via liquid ammonia, forming cooling water and ammonia gas; a turboexpander to expand the ammonia gas and generate electric power; an exothermic absorber, wherein the ammonia gas is contacted with water to form aqueous ammonia; a flash ammonia generator to form a higher pressure ammonia gas; a liquefying unit to liquefy the second ammonia gas for use as a coolant in the flooded tube chiller, wherein the liquefying unit comprises a condenser, a turboexpander generator, and a Joule-Thompson valve.

The present invention can achieve a number of advantages including the manufacture of hydrogen and hydrogen derivatives from coal, pet-coke, and/or petrochemical waste products and the separation and capture of carbon dioxide and sulfur, and abating nitrogen oxides into nitrogen gas and water as described herein.

Conventionally, amine salts, solvents and other processes are used to capture carbon; however, conventional emission capture efficiency is limited to approximately 85-90%. The methods and systems of the present disclosure, however, result in greater than 90% carbon dioxide capture efficiency (e.g., greater than about 95%, greater than about 99%), greater than about 90% capture of sulfur dioxide and nitrogen oxides (e.g., greater than about 95%, greater than about 99%, greater than about 99.998%, near 100%), and abatement levels well below regulations, with significant cost efficiencies, all while utilizing coal, pet-coke, and/or waste products as feed fuels for the processes of ammonia and ammonia derivatives.

These and other advantages will be apparent from the disclosure of the aspects, embodiments, and configurations contained herein.

As used herein, unless otherwise specified, the term “blue hydrogen” refers to hydrogen produced from natural gas and/or coal and petcoke and supported by carbon capture and storage, where the carbon dioxide generated during the manufacturing process is captured and stored permanently underground. The result of “blue hydrogen” is low-carbon hydrogen that produces no carbon dioxide.

As used herein, unless otherwise specified, the term “turquoise hydrogen” refers to hydrogen produced from a process where a hydrocarbon fuel is thermally cracked into hydrogen and carbon.

As used herein, unless otherwise specified, the term “blue ammonia” refers to ammonia that is made from nitrogen and “blue hydrogen” derived from natural gas feedstocks and/or coal and petcoke, with the carbon dioxide by-product from hydrogen production being captured and stored.

As used herein, unless otherwise specified, the term “liquefaction” refers to a process by which a substance is liquefied or converted to a dense phase.

While specific embodiments and applications have been illustrated and described, the present disclosure is not limited to the precise configuration and components described herein. Various modifications, changes, and variations which will be apparent to those skilled in the art may be made in the arrangement, operation, and details of the methods and systems disclosed herein without departing from the spirit and scope of the overall disclosure.

As used herein, unless otherwise specified, the terms “about,” “approximately,” etc., when used in relation to numerical limitations or ranges, mean that the recited limitation or range may vary by up to 10%. By way of non-limiting example, “about 750” can mean as little as 675 or as much as 825, or any value therebetween. When used in relation to ratios or relationships between two or more numerical limitations or ranges, the terms “about,” “approximately,” etc. mean that each of the limitations or ranges may vary by up to 10%; by way of non-limiting example, a statement that two quantities are “approximately equal” can mean that a ratio between the two quantities is as little as 0.9:1.1 or as much as 1.1:0.9 (or any value therebetween), and a statement that a four-way ratio is “about 5:3:1:1” can mean that the first number in the ratio can be any value of at least 4.5 and no more than 5.5, the second number in the ratio can be any value of at least 2.7 and no more than 3.3, and so on.

The embodiments and configurations described herein are neither complete nor exhaustive. As will be appreciated, other embodiments are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is an example ammonia production process, according to embodiments of the present disclosure;

FIG. 2 is an example petcoke and coal slurry emulsification system, according to embodiments of the present disclosure;

FIG. 3 is an example petcoke and coal solid gasification system, according to embodiments of the present disclosure;

FIG. 4 is an example air separation unit (ASU) system, according to embodiments of the present disclosure;

FIG. 5 is an example water gas shift system, according to embodiments of the present disclosure;

FIG. 6 is an example sour gas capture system, according to embodiments of the present disclosure;

FIG. 7 is an example pressure swing adsorption (PSA) system with cryogenic carbon dioxide capture and tail gas recycle, according to embodiments of the present disclosure;

FIG. 8 is an example ammonia synthesis system with ASU cryogenic nitrogen integration, according to embodiments of the present disclosure;

FIG. 9 is an example ammonia sulphate production system via hydrogen sulfide and sulfur (e.g., disulfur, hexasulfur, octasulfur) combustion, according to embodiments of the present disclosure;

FIG. 10 is an example nitric acid production system, according to embodiments of the present disclosure;

FIG. 11 is an example ammonium nitrate production system, according to embodiments of the present disclosure;

FIG. 12 is an example combined heat and power system, according to embodiments of the present disclosure;

FIG. 13 is an example water treatment system, according to embodiments of the present disclosure;

FIG. 14 is an example of utilities and offsites, according to embodiments of the present disclosure; and

FIG. 15 is an example ammonia water cycle for combined cooling and power, according to embodiments of the present disclosure.

### DETAILED DESCRIPTION

Unless defined otherwise, all technical and scientific terms used herein have the same meaning as is commonly understood by one of ordinary skill in the art. All patents, applications, published applications, and other publications to which reference is made herein are incorporated by reference in their entirety. If there is a plurality of definitions for a term herein, the definition provided in the Summary prevails unless otherwise stated.

With current understanding and knowledge of the impacts of pollution from carbon dioxide, the methods and systems disclosed herein support that coal and/or coal and petcoke can be continued to be exploited and utilized in a manner that is ecologically safe and responsible by achieving a near-zero consequence to the air, water, wild-life, and land such as via the efficient capture of at least carbon oxides, sulfur oxides, and nitrogen oxides. Coal can continue to be used as an energy source with a high degree of safety to the Earth's climate and citizens with little to no impacts to climate, public safety, and land through cost effective novel systems and integration of processing technologies like oxy-gasification, carbon and sulfur capture and, nitrogen oxides conversion into nitrogen and water. Coal can successfully be used to produce Blue hydrogen and hydrogen derivatives to be used as Blue and/or Green fuels and much needed Blue petrochemicals for agriculture and industry.

Methods and systems are disclosed herein that efficiently utilize coal, pet-coke, asphaltenes and hydrocarbon waste oils and greases as product feeds to manufacture ammonia, ammonium sulfate, nitric acid, ammonium nitrate, or combinations thereof in a manner that results in near-zero carbon emissions, near-zero sulfur emissions, near-zero nitrogen-oxides and near-zero liquid discharge (ZLD). The integration of the processes disclosed herein allows for high recovery of environmental emissions in a cost effective, reliable process in an environmentally responsible manner.

In embodiments, fuel for the disclosed systems may be generated from the gasification of one or more feed products (e.g., coal, petcoke, waste products) into a hydrogen-nitrogen blend for any direct fired fuel requirements of the processes. The coal and/or petroleum coke feed may be gasified with oxygen into a dirty syngas stream for treatment. The syngas may then undergo a water gas shift process to concentrate carbon monoxide (CO) into carbon dioxide. Any carbonyls (COS) may undergo hydrolysis into hydrogen sulfide. The sour gases (i.e., hydrogen sulfide and carbon dioxide) may be captured through a methanol capture process which achieves greater than about 80%, or more particularly greater than about 90% carbon dioxide capture efficiency. The syngas will require further treatment through a PSA (Pressure Swing Absorption) process to generate a greater than about 99% hydrogen purity specification.

The nitrogen required for ammonia synthesis with the purified hydrogen will be washed through a nitrogen wash process; assuring that potential contaminant carryover from the ASU (Air Separation Unit) such as oxygen, helium and others that impact catalytic ammonia synthesis are separated.

All or a majority (greater than 50%, greater than 90%, greater than 99%) of the tail gas produced by the processes disclosed herein may be recycled to the gasifier for thermal destruction through a vapor recovery system. The balance carbon slip (about 10%) from a methanol and carbon dioxide capture process will be further captured using a cryogenic process that will capture the balance of the carbon dioxide. The processes separate any hydrogen, hydrogen sulfide, and carbon monoxide absorbed by the PSA and recycle the tail gases to the gasification process. In some embodiments, a sulfur guard is installed. The separation of hydrogen and carbon monoxide gases from the PSA regeneration may be separated from the cryogenic carbon dioxide through membranes. The captured carbon dioxide (greater than about 95%, greater than about 99%, greater than about 99.99%, about 100%) may be sequestered in a deep well saline aquifer in the area, sequestered permanently through an enhanced oil recovery scheme in the area, or sequestered via some other known method. The EOR sequestration process will involve carbon dioxide recycle back to the reservoir once the produced oil and gases are separated, thus safely sequestering the carbon dioxide forever.

Ammonia synthesis may include a standard ammonia Haber-Bosch process; however, an ammonia compression refrigeration cycle may not be utilized to chill/cool the ammonia. In-lieu, the ASU will be integrated, in some embodiments, with ammonia chillers and cryogenic nitrogen will be utilized to condense the ammonia gas into anhydrous ammonia (about 99% anhydrous ammonia). The anhydrous ammonia may be diluted to about 25% aqueous ammonia and used to manufacture ammonium sulfate by a column wash process. The hydrogen sulfide captured from the methanol capture process may be combusted in a combustion reactor using an air-oxygen blend with the option to oxidize molten sulfur to increase ammonium sulfate production. The ammonium sulfate crystals from the column wash process may be separated, dewatered, dried into a powder and/or granularized into granules (e.g., about 3-3.5 mm granules) for sale as a premium canola fertilizer, for example.

Manufactured anhydrous ammonia (AA ammonia) may feed the manufacture of nitric acid and may also be used as a feed stock for ammonium sulfate production. The combined feedstock of ammonia and nitric acid may be utilized for the manufacture of ammonium nitrate for sales as a superior fertilizer for citrus fruits agriculture or sold in a concentrated form for the manufacture of explosives, for example.

Oxygen combustion of coal and/or petcoke generates very high temperatures that requires temperature controls. High pressure steam is generated by the oxygen combustion. Additionally, hydrogen sulfide and sulfur combustion for sulfur dioxide also generates waste heat. The gas turbine/steam turbine combined heat and power cycle with the HRSG (heat recovery steam generator) of the processes disclosed herein also generate large amounts of steam. All, a majority, or some of the steam produced may be used for process heat, and the high pressure steam may be used for steam turbine power generation for internal plant consumption with the balance optionally going into the power transmission grid for sales. A black-start gas-turbine generator using hydrogen or ammonia fuel may also be integrated. The water shift reactor processes, ammonia synthesis, nitric acid and ammonium nitrate processes are all exothermic, therefore, any waste heat may be integrated into the overall steam balance making the integrated process very high in energy efficiency.

A vapor recovery system may combine all tail gases from the processes to feed the gasifier as energy making the overall process integration highly efficient and environmentally responsible.

The ammonia-water cycle cooling and power may be integrated as a low grade heat recovery system and may also be utilized in the cooling water process avoiding the need for a cooling water tower and may also reduce water consumption. The largest water load for the process is cooling water and the associated water loss through evaporation to atmosphere. The ammonia-water cycle cooling system significantly reduces water consumption for the process.

The ASU process products may be utilized to operate in a refrigerant capacity and also may be applied to any other process refrigeration cycles such as other liquefaction processes, and chemical processes that normally would utilize a compression, chiller, and regeneration refrigeration process, either in an integrated manner or in a cascaded fridge cycle to separate or condense a gas stream.

The present discloser is of significant importance in hydrogen generation from coal and/or pet-coke and other solid gasification methods utilizing oxygen gasification, inclusive but not limited to biomasses and any other material containing calorific values that can be gasified or converted into hydrogen gas for electric energy or petrochemical utilization. This process also applies to biomass and biofuels pyrolysis processes and any other processes utilizing an ASU to generate oxygen for the manufacture of hydrogen and hydrogen derivatives such as fertilizers. The present disclosure also applies to power generation methods using coal or pet-coke to capture and separate sulfur and carbon dioxide as a capture process and methods of liquefaction involving hydrogen production from coal or pet-coke for ammonia and ammonia derivative processes.

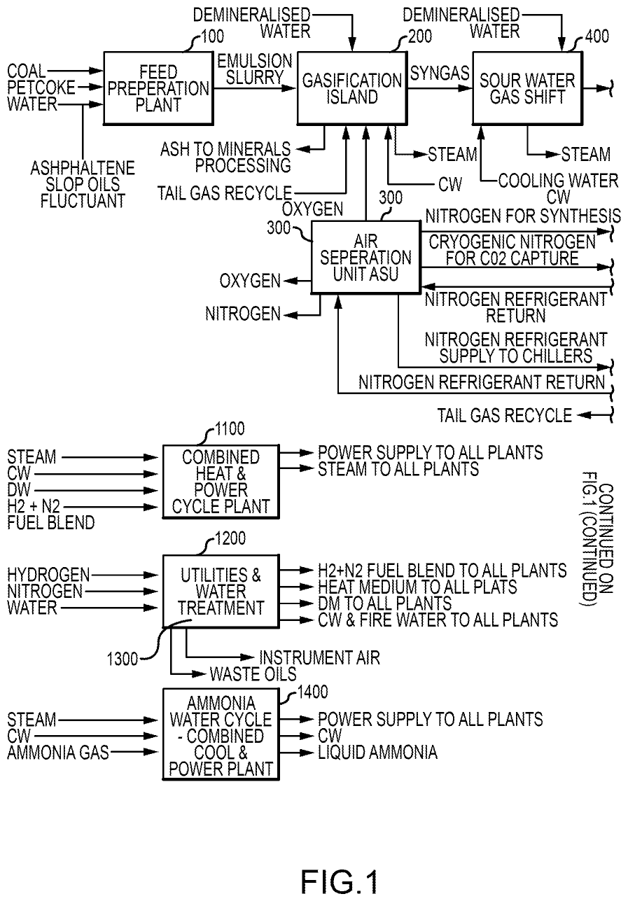

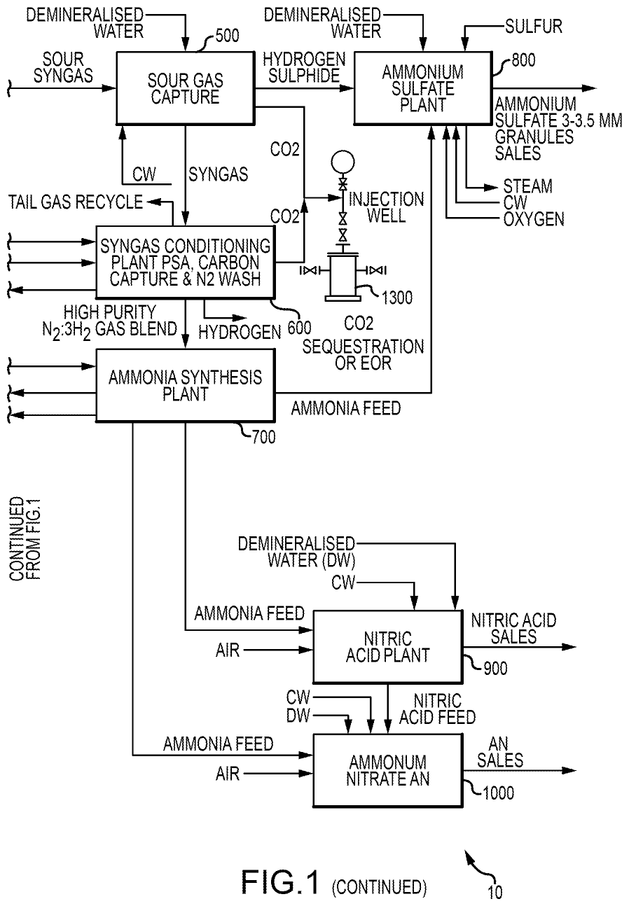

FIG. 1 depicts example ammonia production process 10, according to embodiments of the present disclosure. The process 10 may be an example Blue coal-petcoke to ammonia process. FIG. 1 provides an overall coal and pet-coke to: hydrogen fuel, anhydrous ammonia, ammonium sulfate, nitric acid, and ammonium nitrate through a gasification process for clean hydrogen. Blue ammonia is a product of significant interest not only as a fertilizer for food production and other uses such as petrochemicals, explosives, etc., but also as a fuel for power, marine, rail, and other transport methods, blended with combustion accelerants. FIG. 100 may include a system 100, a system 200, a system 300, a system 400, a system 500, a system 600, a system 700, a system 800, a system 900, a system 1000, a system 1100, a system 1200, a system 1300, and a system 1400.

Briefly, system 100 is directed to feedstock preparation. System 200 is directed oxygen-based gasification. System 300 is directed to an ASU providing nitrogen for ammonia synthesis and as a cryogenic refrigerant for carbon capture in system 600, and providing oxygen to the gasifiers of system 200. System 400 is directed to a sour water gas shift to concentrate carbon monoxide into carbon dioxide and convert carbonyls (COS) to hydrogen sulfide. System 500 is directed to sour gas (e.g., H₂S, CO₂) capture comprising a methanol based solvent capturing at least about 90% of the carbon dioxide and at least about 99% of the hydrogen sulfide. System 600 is directed to syngas conditioning and comprises a regenerative PSA producing a high purity hydrogen stream (i.e., comprising at least about 90% hydrogen, at least about 95%, at least about 99%, at least about 99.9%, or about 100% hydrogen), and comprising carbon capture technology and a nitrogen wash to remove air gas contaminants. The PSA regeneration gases may cryogenically remove the remaining entrained carbon dioxide from the methanol sour gases capturing the about 10% balance of the carbon dioxide that slipped the capture process. Off-gasses of system 600 may be recycled through a vapor recovery unit (VRU) to a gasifier. System 700 comprises Haber-Bosch ammonia synthesis integrated with the cryogenic nitrogen generated by the ASU, voiding the requirements of an ammonia refrigeration system to condense the anhydrous ammonia into liquid. System 700 comprises the potential to use the ammonia-water cycle as a coolant or use to cool cooling water in geographic areas where cooling water is at a premium to condense the steam turbine driven ammonia synthesis compressor. System 800 comprises an ammonia sulfate wash reactor, where hydrogen sulfide and in some embodiments, molten sulfur to augment sulfur, are combusted into sulfur dioxide to manufacture high quality ammonium sulfate. Greater than about 90%, greater than about 95%, greater than about 99%, or about 100% sulfur dioxide capture efficiency, dewatering, drying and granularizing of the ammonium sulfate for market may be achieved. System 900 comprises a nitric acid production process, where the nitric acid may be used as feedstock to produce ammonium nitrate (in system 1000) and remaining nitric acid may be sold in industrial markets. The nitric acid may be concentrated (e.g., comprising about 96% to about 98% nitric acid) or diluted (e.g., comprising about 23% to about 26% nitric acid). System 1000 comprises an ammonia nitrate (AN) production process, with or without pirlling for a liquid concentrate for agriculture citrus fertilizer or for explosives grade ammonia nitrate. Depending on the product outcome to be manufactured, system 1000 can be integrated with other processes.

System 1100 comprises a combined heat and power process that optimizes waste heat from all or a majority of streams in process 10 and integrates heat into low pressure (LP) and medium pressure (MP) steam with MP and HP steam for mechanical steam drive of plant equipment and power generation. A gas turbine generator (GTG) may be used for overall electrical black-start electric loads (recovery from a total or partial system shutdown) of the process 10, thereby reducing power transmission demand and energy costs. A steam turbine generator (STG) condenser can be integrated or replaced with coolants from the ammonia-water cooling cycle for additional power generation. System 1200 comprises utilities and offsites that support the process 10, including but not limited to instrument air, HVAC, emergency LP and HP oxidizer flare, and product storage. System 1300 is directed to water treatment using best available technology for processing water, cooling water, and fire and deluge water and storage. System 1400 is directed to an ammonia water cycle with a combined cooling and power process. System 1400 salvages waste heat streams and provides cooling needs, particularly advantageous in geographical areas where cooling water at a premium due to drought conditions. System 1400 significantly reduces water requirements and converts low grade heat into power where it makes economic sense. The cycle may be used in-lieu of a water cooling tower avoiding capex and significant water consumption through evaporation.

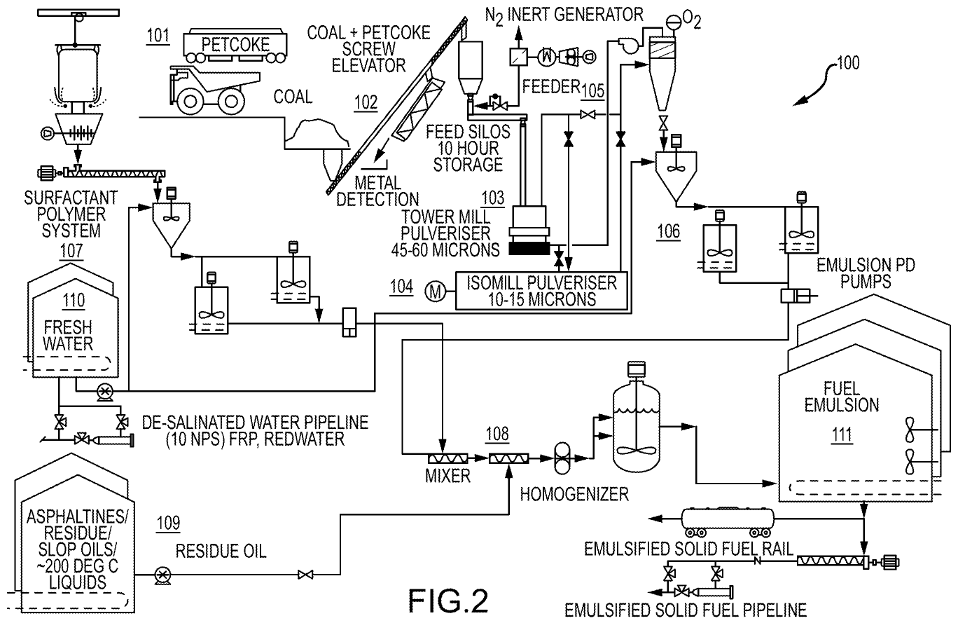

FIG. 2 depicts an example petcoke and coal slurry emulsification system 100, according to embodiments of the present disclosure. System 100 may be integrated into the ammonia production process 10, as described with reference to FIG. 1.

System 100 comprises coal and petcoke feed delivery 101, where the coal may be delivered from a coal mine and the pet-coke may be delivered via rail and truck. An elevator system 102 is implemented to deliver the coal and petcoke to feed silos, where the feed can be stored prior to use. Coal and pet-coke mills 103 are positioned after the silos to mill the coal and petcoke feed to about 80-100 micron. System 100 may then comprise micro-milling 104 to mill the coal and petcoke to about 5-15 microns. Unit 105 comprises a coal classifier with a nitrogen inert system for the mills 103 and 104. Low pressure nitrogen is used to provide a continuous purge to the feed silos mills so that oxygen does not accumulate in levels exceeding than that of lower explosive limits (LEL) (e.g., LEL about zero). Unit 106 comprises coal and pet-coke slurry emulsification and unit 107 comprises an emulsifier feed system. Unit 107 comprises surfactant polymers. Surfactant polymer examples include chemical and earth materials with water and/or oils to form an emulsion suspension comprising coal and/or petcoke material, i.e. pastes, creams, margarines, medicines. Unit 108 comprises a mixer and homogenizer system. Unit 109 stores heated slop oils, refinery oil residue, and asphaltenes. Unit 110 comprises freshwater storage. Unit 111 achieves fuel emulsion via gasification.

The feed stock of system 100 may comprise a blend of coal, pet-coke, and waste materials such as refinery slops and residue, asphaltenes or products that will add to the calorific value of the feed yet with element species that will not impact air emissions. Fluxant materials may be added to control slag and fly ash handling and processing. Fluxant materials may comprise earth materials such as limestone additions to control ash viscosities so that ash does not crystalize into glass and foul the gasifiers and turn the flyash into glass lumps.

Water from the water storage unit 110 may be mixed with the milled coal/petcoke feed to form a slurry. The coal/petcoke slurry may then be mixed, in unit 108, with the surfactant polymer from unit 107 and then be sent to unit 111 to achieve a fuel emulsion comprising a mixture of coal and/or petcoke, surfactant polymers, and water. The emulsified slurry provides for better combustion in the gasifier of system 200, and provides for improved transport and handling and minimizes water usage in the gasification process of system 200. The polymer emulsified fuel allows for greater durability of gasifier slurry systems.

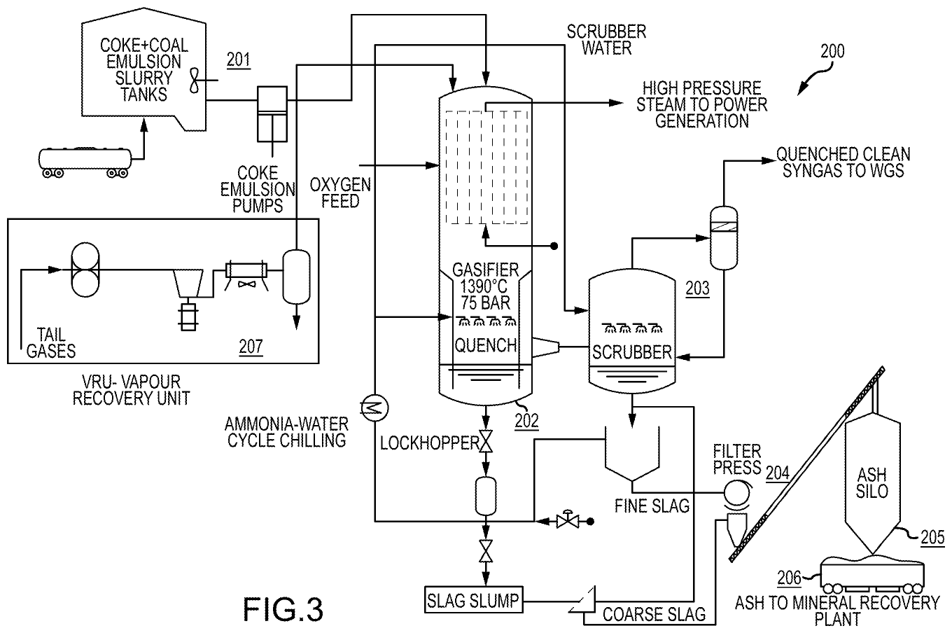

FIG. 3 depicts an example petcoke and coal solid gasification system 200, according to embodiments of the present disclosure. System 200 may be integrated into the ammonia production process 10, as described with reference to FIG. 1. System 200 may follow system 100, where the emulsion slurry of system 100 is directed as in input to system 200.

System 200 comprises emulsion storage and pump unit 201. Unit 202 comprises a gasifier with quench and a HP steam heat recovery system. Unit 203 comprises cooling water with a water scrubber system. Unit 204 comprises slag and ash separation. System 200 additionally comprises ash storage unit 205. Unit 206 comprises ash transport to a coal mine and/or to mineral processing (for mineral recovery). Unit 207 comprises a vapor recovery system to handle and inject all or a majority of off-gasses and process tail-gases into the high temperature gasification process for calorific recovery and emissions reduction. The ammonia-water cool cycle is utilized to chill the gasifier quench maximizing low grade waste heat recovery and optimizing gasifier temperature controls.

The fuel emulsion produced in system 100 is pumped to the gasifier of unit 202 where the fuel emulsion is combusted. The combusted fuel emulsion is then quenched in the gasifier (with water), and the remaining gases are scrubbed in unit 203 resulting in quenched clean syngas. The ash remaining from the gasification in unit 202 and/or the scrubbing unit 203 is handled as slag in units 204 and 205. The ash may comprise a high mineral content, including contents of aluminum, silver, gold, titanium, etc. depending on the feedstock.

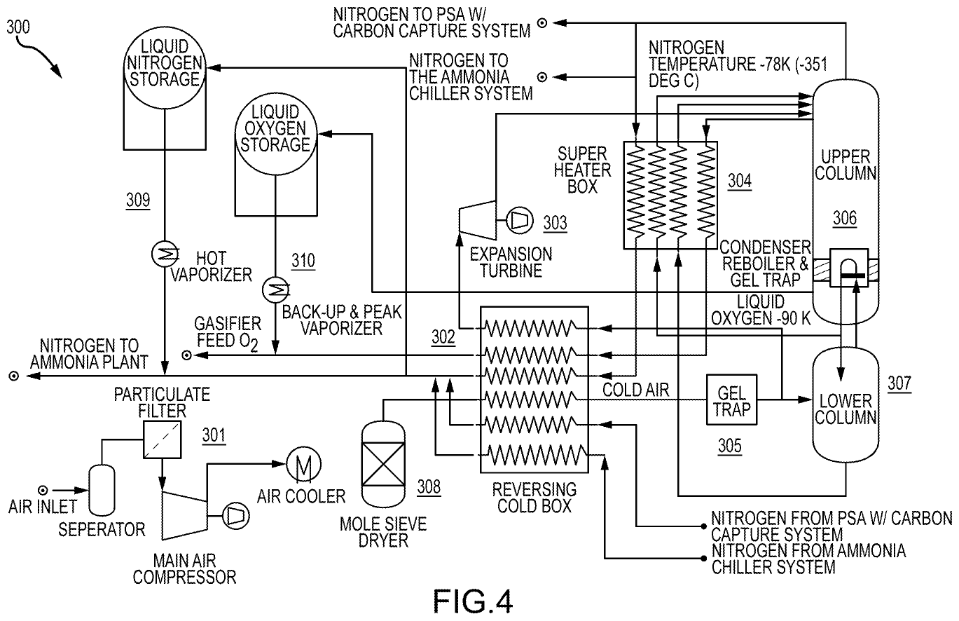

FIG. 4 depicts an example ASU system 300, according to embodiments of the present disclosure. System 300 may be integrated into the ammonia production process 10, as described with reference to FIG. 1. System 300 may comprise a BAC (booster) and a MAC (main) air compressor unit 301 with cooler and air filtration. Unit 301 may provide electric drive only or both steam and electric combined. Unit 302 comprises a reversing cold box with nitrogen refrigerant from PSA cryogenic carbon dioxide capture and anhydrous ammonia liquefaction. Unit 303 comprises a turbine expander for chilling the air products. Unit 304 of system 300 comprises super-critical cold boxes. Unit 305 comprises a gel trap. Unit 306 comprises an upper cryo-distillation of the air with an internal reboiler, a condenser, and a gel trap. Unit 307 comprises a lower cryo-separation column. Unit 308 comprises a mole sieve air dryer. Unit 309 comprises a liquid nitrogen storage tank with pumps and vaporizers. Unit 310 comprises a liquid oxygen tank with pumps and vaporizers.

In system 300, air (e.g., from the environment, atmosphere) is used an input to unit 301 where the air is filtered and compressed. After the compression, the temperature of the air is hot so the air is then sent through a cooler. The air is the dried via mole sieve dryer unit 308 and then refrigerated in reverse cold boxes of unit 302, forming liquid air. The liquid air is then distilled via cycling through units 302, 303, 304, 306, 307, and 305 resulting in separated nitrogen and oxygen streams for use in process 10. In some embodiments, the oxygen may be used in the gasifier of unit 202. In some embodiments, the nitrogen is utilized for ammonia synthesis, or utilized as cryogenic nitrogen for carbon dioxide in system 600. In some embodiments, the nitrogen is utilized as a refrigerant supply to the chillers of system 700.

Cryogenic nitrogen may be used as a refrigerant in the ammonia plant to condense the ammonia gas from synthesis and in the PSA to condense the carbon dioxide product. Should the ASU be designed with extraction of noble air gases such as argon, helium etc., the ASU gases may be utilized not only for the liquefaction of carbon dioxide, and refrigerant, but also the liquefaction of hydrogen for use in transportation supporting the energy transition to net-zero fuels as a Blue fuel. The BAC and MAC air compressor of unit 301 is electric driven. The black start gas turbine generator of process 10, as a minimum, will need to meet the electric load requirements of the ASU. A tandem gas turbine and generator drive train may also be considered for the ASU.

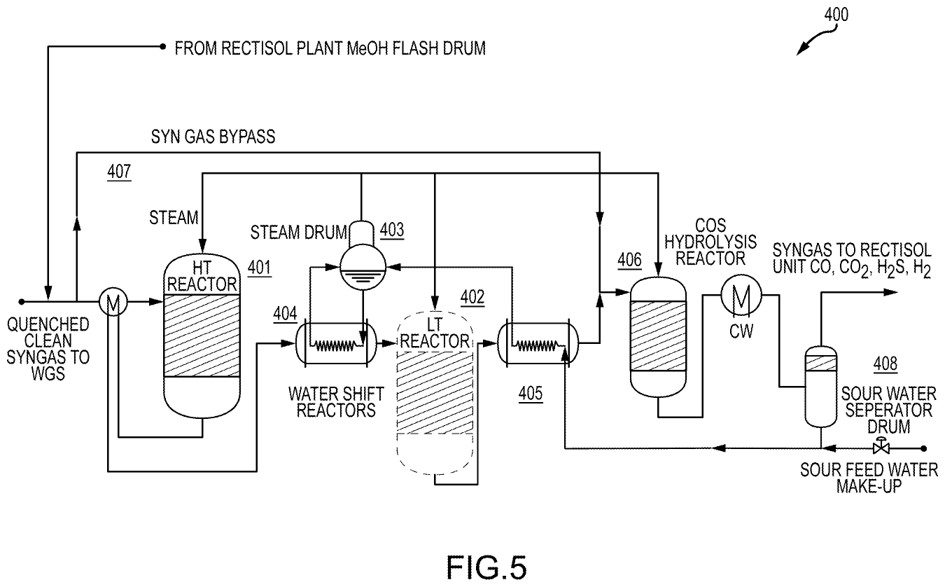

FIG. 5 depicts an example water gas shift system 400, according to embodiments of the present disclosure. System 400 may be integrated into the ammonia production process 10, as described with reference to FIG. 1. System 400 may comprise a high temperature water shift reactor 401, and a low temperature water shift reactor 402. System 400 may additionally comprise a steam drum and high pressure steam heat recovery system 403. Unit 404 comprises a heat recovery exchanger. Unit 405 comprises a heat recovery exchanger. Unit 406 comprises a carbonyl (e.g., COS, among others) to hydrogen sulfide shift reactor. Unit 407 comprises a sour gas shift bypass loop for carbon monoxide and carbon dioxide control. Unit 408

The quenched syngas from system 200 may comprise sulfur, carbon monoxide, carbon dioxide, hydrogen, hydrogen sulfide, carbonyl sulfide, or combinations thereof. The quenched syngas may comprise majority (e.g., at least about 50%, and more particularly at least about 80%, and more particularly at least about 90%, and more particularly at least about 95%, and even more particularly at least about 99%) carbon dioxide, hydrogen sulfide, and hydrogen. The balance of the quenched syngas may comprise carbon monoxide and carbonyl sulfide. As such, the quenched syngas is input to system 400 through a multi-stage, fixed-bed reactor (i.e., units 401 through 406) comprising shift catalysts to convert carbon monoxide and water into additional hydrogen and carbon dioxide. A portion of the quenched syngas may be bypassed via unit 407 to control the amount of carbon monoxide for other petrochemicals, where the bypassed syngas is then inserted into unit 406. The resulting syngas from system 400 comprises carbon dioxide, carbon monoxide, hydrogen sulfide, and hydrogen.

In some embodiments, a portion of the quenched syngas may be passed for future methanol and synthetic oil and wax manufacturing such as Fisher Troupe that relies on carbon monoxide for synthesis. The syngas bypass may not be utilized for anhydrous ammonia and is only an illustration for future petrochemicals such as FT synfuels and wax and methanol that requires a CO to CO2 ratio.

Sour gas shift bypass loops conventionally associated with unit 407 may not be necessary as the process does not require carbon monoxide and maximizing carbon dioxide conversion is the objective. The sour gas shift bypass is normally required for Fisher Troupe and methanol synthesis to achieve the right stoichiometry in the syngas for these products.

Units 403, 404, and 405 may capture the exothermic waste heat from the shift reactors to produce high pressure and temperature steam for integration with the combined heat and power facility (CHP). The steam quality may be further integrated with the GTG duct fired HRSG to optimize the MP and HP steam cycles for the facility.

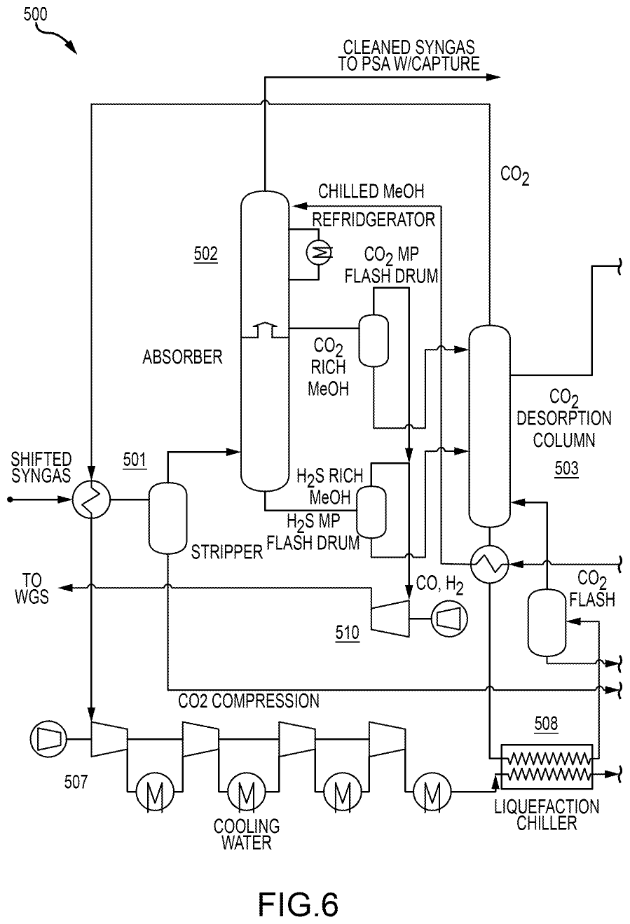

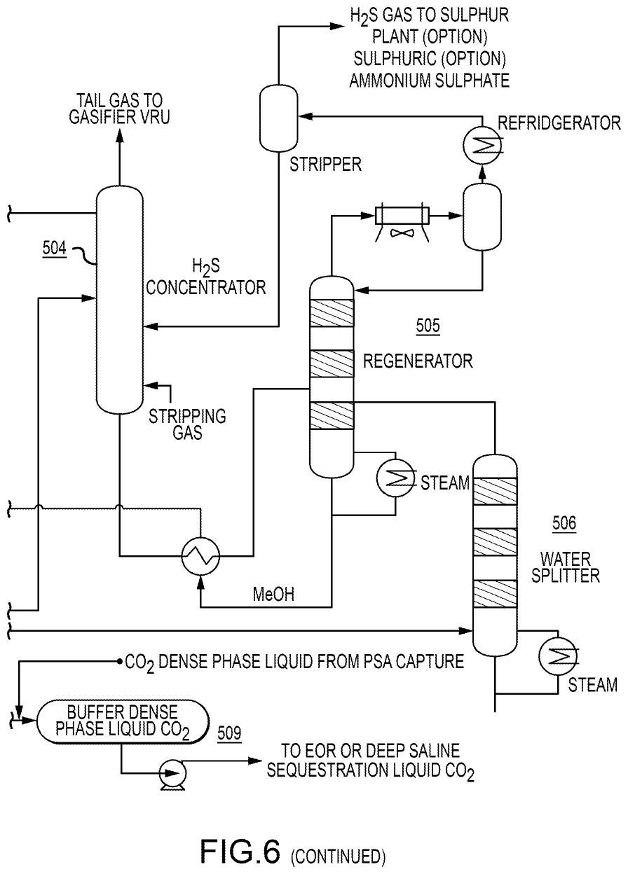

FIG. 6 depicts an example sour gas capture system 500, according to embodiments of the present disclosure. System 500 may be integrated into the ammonia production process 10, as described with reference to FIG. 1. System 500 may comprise shift gas inlet water stripper separator 501. Unit 502 may comprise a hydrogen sulfide and carbon dioxide contactor absorber. Unit 503 may comprise a carbon dioxide and methanol de-absorption separation. Unit 504 may comprise a hydrogen sulfide concentrator column. Unit 505 may comprise methanol regeneration with a hydrogen sulfide stripper. Unit 506 may comprise a water stripper. Unit 507 may comprise carbon dioxide gas compression and liquefaction. Unit 508 a carbon dioxide liquefaction chiller. Unit 509 comprises a carbon dioxide buffer tank storage and pump system to decouple field EOR and sequestration from the plant complex. Unit 510 comprises an overhead compressor for off-gases recycle to upstream of sour water gas shift (SWGS) of system 400.

Hydrogen sulfide is separated by unit 504 from a sour syngas stream from system 400, where it is then regenerated in unit 505 before being sent to a sulfur production system, a sulfuric acid production system, an ammonium sulfate production system (system 800), or is split between a combination thereof. Carbon dioxide is separated from the sour syngas stream from system 400 via unit 503 and sent to unit 507 for compression and then unit 508 for liquefaction, resulting in dense phase carbon dioxide that can be stored via unit 509 and then directed to sequestration system 1300. The remaining (“cleaned”) syngas comprising carbon monoxide, carbon dioxide, traces of air from the ASU (e.g., oxygen, nitrogen, noble gases) is sent to system 600.

The captured hydrogen sulfide is used for ammonium sulfate production, however it can also be integrated and used in a sulfur and/or sulfuric acid production plant. The ammonium sulfate product provides the most economic basis or profitable price for hydrogen sulfide capture. The manufacture of ammonium sulfate in the present disclosure will yield about a 2.8 multiplier on the ammonia produced in the complex (i.e. ammonia manufactured with the sulfur dioxide and sulfur to produce ammonium sulfate as a complex co-stream) with a much reduced capex and opex compared to the sulfuric acid route to ammonium sulfate.

The methanol capture process captures hydrogen sulfide at very high levels, however because ammonia catalysts are sensitive to sulfur species, a zinc bed may be integrated for added assurance in the event of an operating excursion.

A deoxygenation system may be necessary to meet a particular specification of oxygen content in the carbon dioxide.

The carbon dioxide compressor train of unit 507 depicted in FIG. 6 comprises an electric driven multistage integral unit; however, it may be steam driven for greater cost and operating efficiencies.

Dense or liquid phase carbon dioxide storage may be mandatory due to the need to decouple the plant facilities from the EOR sequestration and deep saline aquifer sequestration storage. Several carbon dioxide injection wells may be required in the event there is a short-term unavailability of sequestration. The injection wells may also allow for charging the pipeline injection system with cryogenic carbon dioxide. A 24 to 48-hour carbon dioxide storage may be utilized, which may allow for setting field inject pressure with a pump system for carbon dioxide, further reducing the Capex and Opex costs and sizes of the carbon dioxide compressor for high pressure injection.

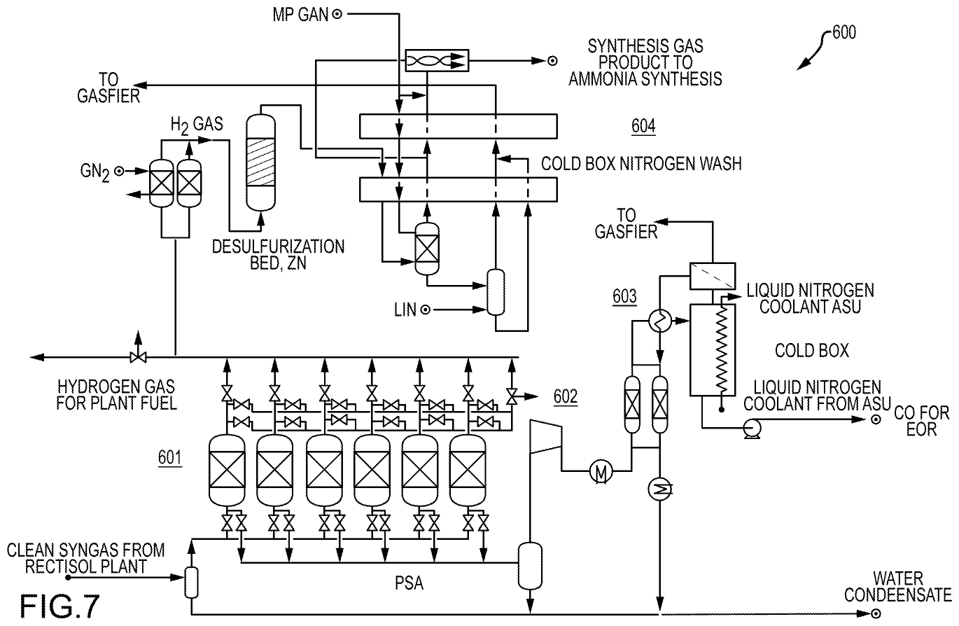

FIG. 7 depicts an example pressure swing adsorption (PSA) system 600, according to embodiments of the present disclosure. System 600 may be integrated into the ammonia production process 10, as described with reference to FIG. 1. The PSA system 600 may be integrated with cryogenic carbon dioxide capture and tail gas recycle.

The PSA system 600 may comprise a PSA unit 601 and a PSA vacuum compressor 602. Unit 603 of PSA system 600 comprises a tail gas mole sieve dryer and liquefaction cold boxes. Unit 604 comprises a nitrogen wash system to decontaminate the nitrogen and hydrogen (3H₂:N₂ Kmole basis) blend stream for anhydrous ammonia synthesis.

The syngas from system 500 is directed to the PSA of unit 601 that removes impurities from the syngas (e.g., noble gases, oxygen, nitrogen, carbon dioxide, carbon monoxide) to output a pure hydrogen gas. All or a portion of the hydrogen may be used as fuel, such as for process 10. Additionally or alternatively, the hydrogen may be sent through a desulfurization bed to remove any remaining sulfur and is then mixed with nitrogen in unit 604 forming a high purity nitrogen and hydrogen gas blend (i.e., in a ratio of 1:3 nitrogen to hydrogen) that can utilized for ammonia synthesis, such as in system 700. Any impurities removed from unit 604 may be directed to the gasifier of system 200 for re-processing. The contaminant gases captured in the PSA are released, compressed (via unit 602), and then dried and cooled (via unit 603), resulting in liquid carbon dioxide comprising at least about 90%, or at least about 95%, or least about 99% carbon dioxide. The carbon dioxide is directed to sequestration system 1300. Liquid nitrogen may be cycled between ASU of system 300 and unit 603 as a coolant.

Traces of carbon oxides, argon, helium, oxygen, methane, and others may be removed through process equipment of the cryogenic separation installed in the cold box, which may be covered with a metal shell. The cold box void may be filled with insulation material (e.g., Perlite) to prevent heat input. The cold box is typically completely prefabricated and delivered in one piece to a site.

The liquid nitrogen wash is primarily used to purify and prepare ammonia synthesis gas for the process. It is usually the last purification step upstream of ammonia synthesis. The liquid nitrogen wash has the function to remove residual impurities from a crude hydrogen stream and to establish the stoichiometric ratio of H₂ to N₂. Carbon monoxide and sulfur must be completely (or near completely) removed because they are poisonous for the ammonia synthesis catalyst. Argon, and methane are inert components enriching the ammonia synthesis loop, and if not removed, a syngas purge or expenditures for purge gas separation may be required.

Raw hydrogen and high pressure nitrogen may be fed to the liquid nitrogen wash unit. Both streams are cooled down against product gas. Feeding raw hydrogen to the bottom of the nitrogen wash column and some condensed nitrogen liquid to the top. Trace components are removed and separated as fuel gas and circulated to the syngas process. To establish the desired H₂/N₂ ratio, high pressure nitrogen is added to the process stream. Tail gases are gathered through the vapor recovery system into the gasifiers to minimize emissions.

The disclosed process of system 600 may be compatible with an amine based solvent for the carbo dioxide and hydrogen sulfide capture, and may require a syngas mole sieve dryer. However, a methanol based solvent does not require drying of the syngas prior to the N₂ wash process.

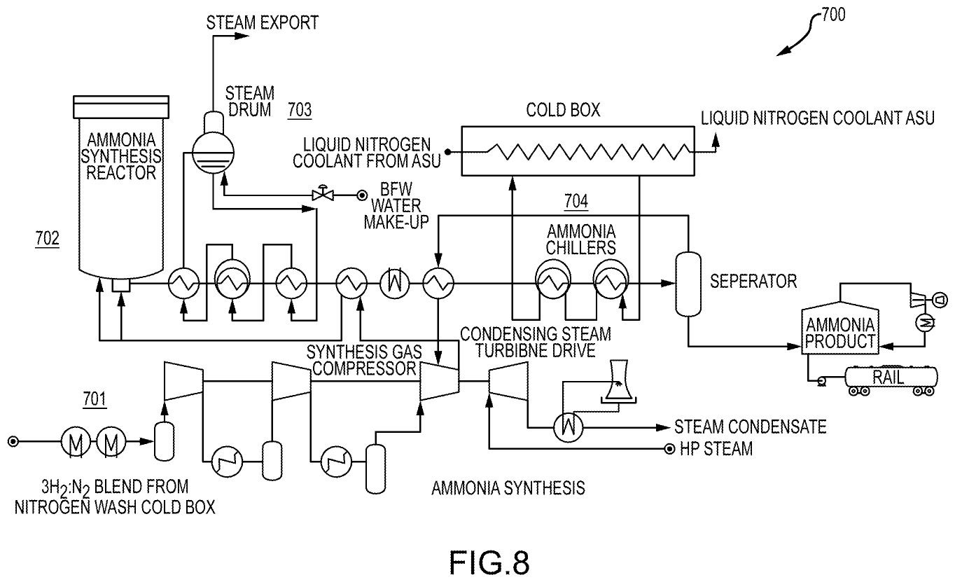

FIG. 8 depicts an example ammonia synthesis system 700 with ASU cryogenic nitrogen integration, according to embodiments of the present disclosure. System 700 may be integrated into the ammonia production process 10, as described with reference to FIG. 1.

System 700 may comprise unit 701 comprising a steam turbine driven cleaned syngas compression and recycle gas compressor train. Unit 702 of system 700 comprises an anhydrous ammonia synthesis reactor. Unit 703 comprises HP steam heat recovery, and unit 704 comprises ammonia liquefaction integrated with cryogenic ASU nitrogen refrigerant. System 700 may utilize the Haber-Bosch process to produce ammonia from the nitrogen.

The high purity blend of nitrogen and hydrogen from system 600 (in a particular stoichiometric ratio of 3H₂:N₂) is input to system 700 and is then compressed in unit 701 to a particular pressure before passing through a series of one or more heat exchangers and being input to the ammonia synthesis reactor of unit 702. Output from the ammonia synthesis reactor is hot ammonia that is then passed through a series of one or more heat exchangers to cool the ammonia. The ammonia may then be directed to a cold box of unit 704 (utilizing nitrogen from the ASU of system 300 as a coolant) to further cool the ammonia gas to a mixture of ammonia liquid and gas. The ammonia gas is separated and sent back through system 700. The separated ammonia liquid may then be stored in a tank or otherwise directed to ammonium sulfate production system 800, nitric acid production system 900, and/or ammonium nitrate production system 1000.

The steam turbine may be a fully condensing steam turbine unit that requires cooling water (CW). Cooling water may be chilled through the ammonia-water cooling cycle, particularly in geographical areas where water is limited due to droughts. This may be an integrated chilled water system without a need for an evaporative cooler that loses large volume of cooling water through evaporation to the atmosphere.

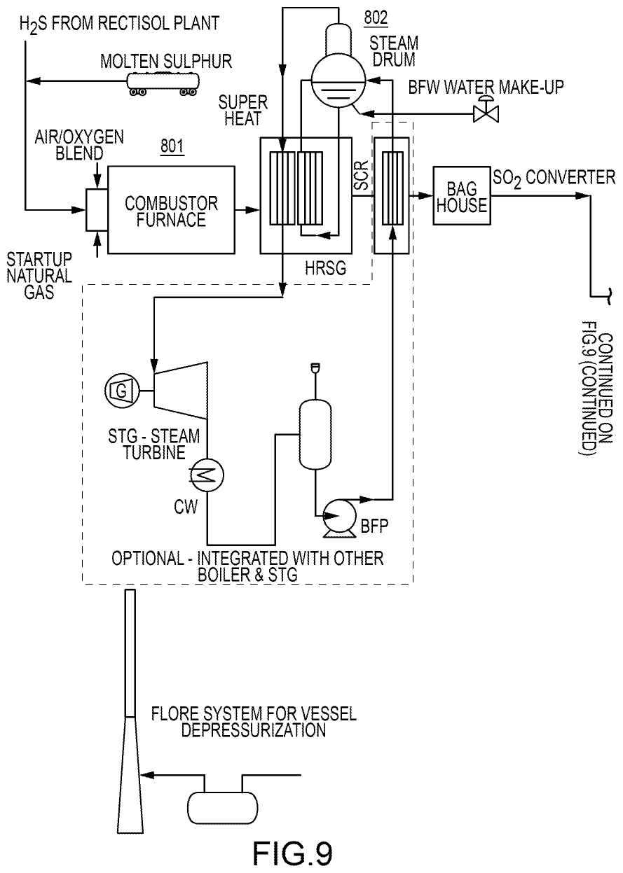

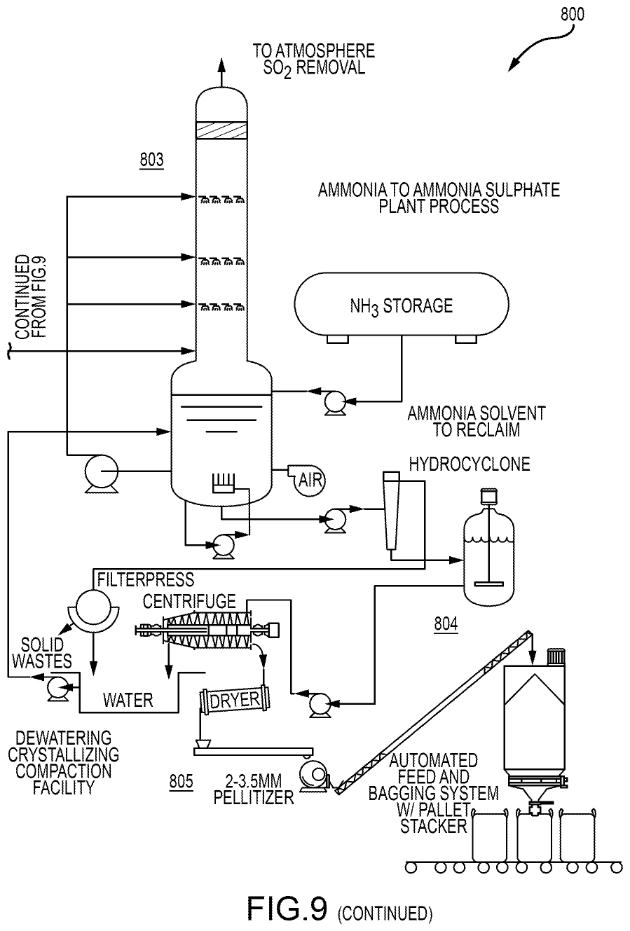

FIG. 9 depicts an example ammonia sulphate production system 800 via hydrogen sulfide and sulfur (e.g., disulfur (S₂), hexasulfur (S₆), octasulfur (S₈)) combustion, according to embodiments of the present disclosure. System 800 may be integrated into the ammonia production process 10, as described with reference to FIG. 1.

System 800 may comprise a unit 801 for acid gas combustion with waste heat recovery of sulfur dioxide with nitrogen oxide abatement using the ammonia wash to achieve ultralow emissions. Unit 802, as depicted in FIG. 9, comprises HP steam heat recovery for power generation. Unit 803 comprises an aqueous ammonia wash reactor with a circulating tank and pump system. Unit 804 comprises an ammonium sulfate crystal dewatering system. Unit 805 comprises drying the ammonium sulfate crystals into a powder and/or palletization to ammonium sulfate market specifications.

The hydrogen sulfide from system 500 may be combined with molten sulfur and combusted in unit 801 with an air/oxygen blend resulting in sulfur dioxide. Waste heat from unit 802 (for power generation) may be used to control the temperature of the furnace of unit 801. The sulfur dioxide may be passed through a baghouse to remove sulfur ash and then directed to an aqueous ammonia wash reactor of unit 803. An aqueous ammonia blend comprising about 25% ammonia and 75% water is also input to the aqueous ammonia wash reactor of unit 803. As the aqueous ammonia solution contacts the sulfur dioxide in the aqueous ammonia wash reactor, crystals of ammonium sulfate form. The crystals are dried and compacted via units 804 and 805 for market.

The absorber releases a clean gas to the atmosphere, where at least about 90% of the sulfur dioxide is removed, or more particularly at least about 95% of the sulfur dioxide is removed, or more particularly at least about 99% of the sulfur dioxide is removed, or more particularly at least about 99.999% of the sulfur dioxide is removed, or more particularly about 100% of the sulfur dioxide is removed from the gas that is released.

Conventionally, ammonium sulfate is manufactured through processing sulfuric acid and ammonia together, however, the process disclosed herein is commercially proven with the environmental capture of sulfur dioxide to achieve very high emission reductions (greater than 95%, greater than 99%, near 100% emission capture) and without the needed of sulfuric acid. The disclosed process is simple, cost effective and profitable as hydrogen sulfide and sulfur dioxide are achieved by combustion, the ammonia wash to ammonia sulfate reaction times are fast and ammonia sulfate crystals are easily dried to a sugar and granularized.

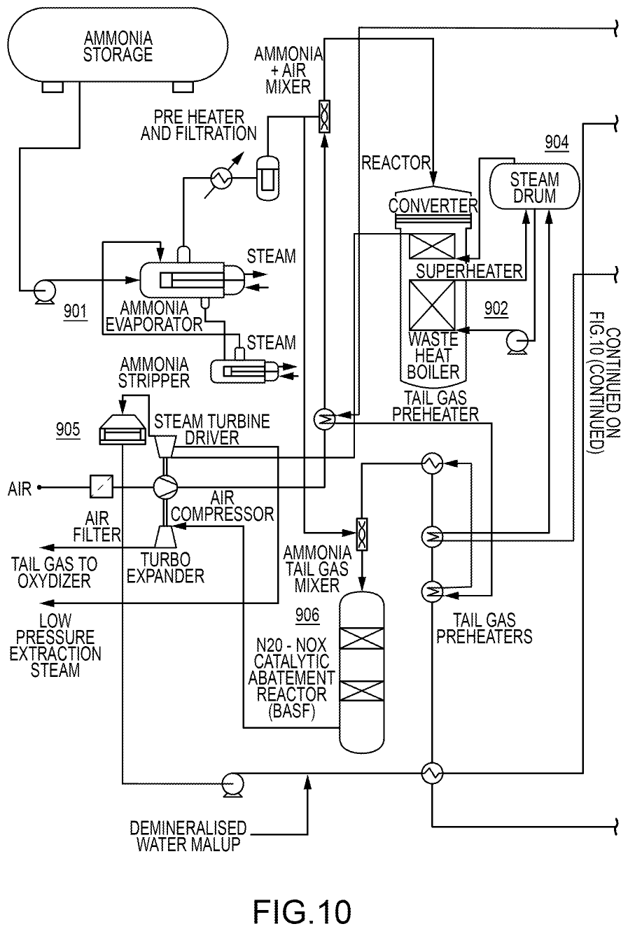

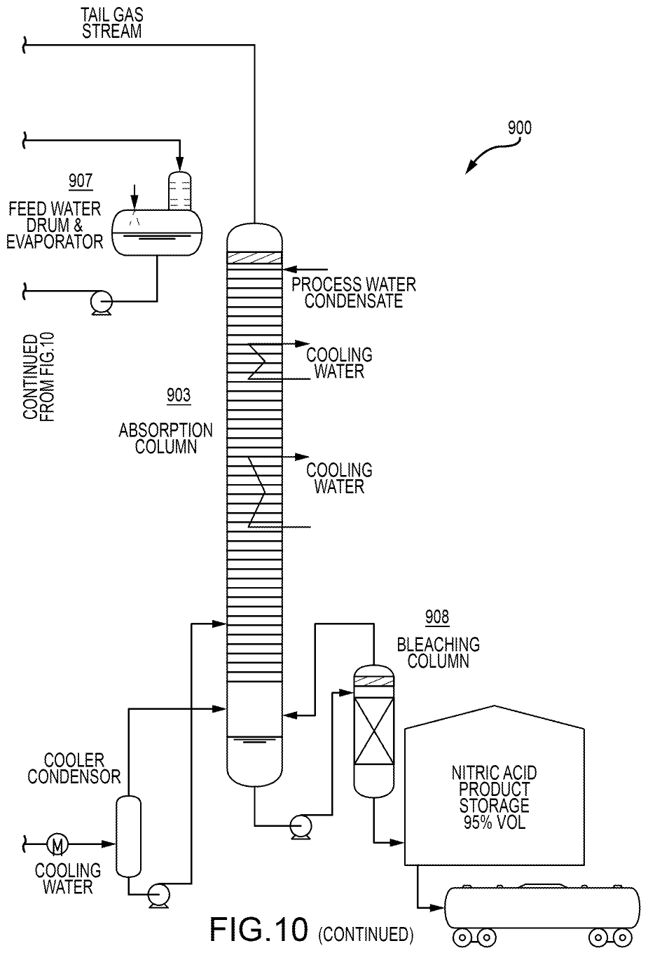

FIG. 10 depicts an example nitric acid production system 900, according to embodiments of the present disclosure. System 900 may be integrated into the ammonia production process 10, as described with reference to FIG. 1.

The system 900 may comprise unit 901 comprising anhydrous ammonia evaporators, such as a main evaporator (i.e., primary ammonia evaporator) and an ammonia stripper (i.e., a secondary ammonia evaporator for reduced and cold startup). Unit 902, as depicted in FIG. 10, comprise a nitric acid conversion reactor (e.g., comprising a converter operating at about 860 degrees Celsius). Unit 903 comprises an oxidation and absorption column. Unit 904 comprises a HP steam drum and waste heat recovery system. Unit 905 comprises integral process air with filtration and a tail gas turbine expander on a fully condensing steam driven compressor train. Unit 906 comprises a BASF or equivalent NOₓ abatement catalytic reactor. Unit 907 comprises a demineralized feed water system for steam generation. Unit 908 comprises a bleaching column.

The ammonia from system 700 is input to system 900 to produce the nitric acid. With ammonia availability on site, NOₓ abatement is achieved at a very high efficiency. Nitric acid may be used as a precursor to ammonium nitrate. As such, the nitric acid produced in system 900 may be sent to the ammonium nitrate production system 1000.

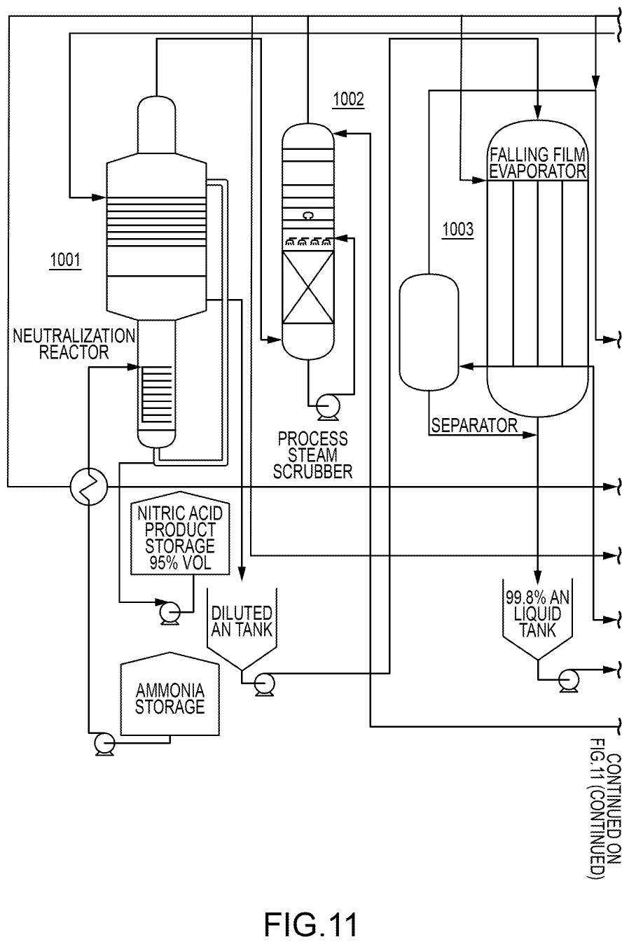

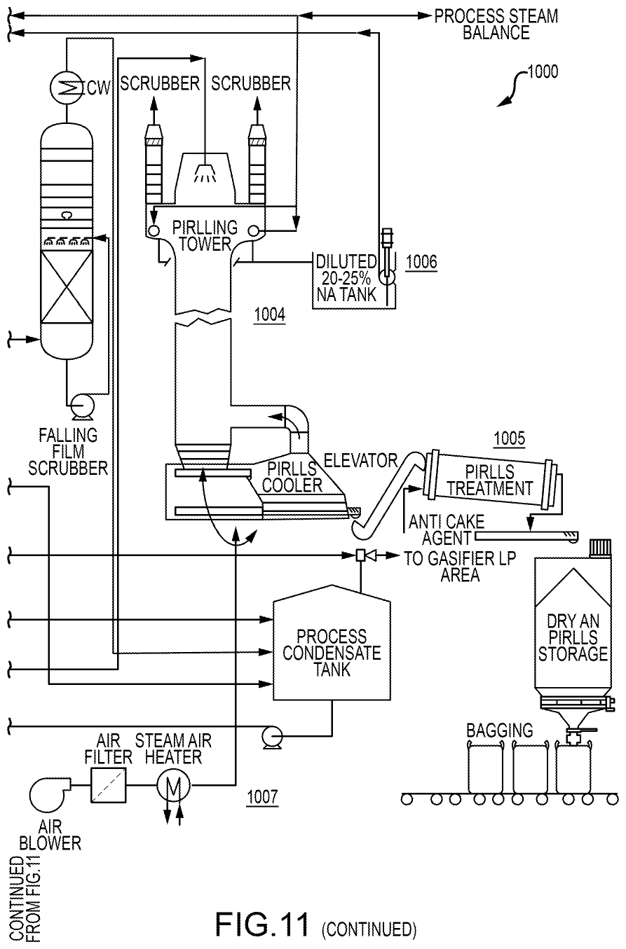

FIG. 11 depicts an example ammonium nitrate production system 1000, according to embodiments of the present disclosure. System 1000 may be integrated into the ammonia production process 10, as described with reference to FIG. 1.

System 1000 may comprise a unit 1001 comprising a neutralization reactor, which may be supplemented 2×75% trains or 2×100% trains (i.e., the system 1000 comprises 100% redundancy trains 2×100%, or to economize, 2×75% trains in which 25% of production is lost if one trains is down and offline for service). Unit 1002 depicted in FIG. 11 may comprise a process steam scrubber. Unit 1003 comprises a falling film evaporator, unit 1004 comprises a pirlling tower with pirlls cooling, and unit 1005 comprises pirll treatment and granularization. Unit 1006 comprises a nitric acid recycle and unit 1007 comprises air conditioning air for pirlling tower cooling.

The nitric acid produced in system 900 and the ammonia produced in system 700 may be input to system 1000 to produce the ammonium nitrate.

Ammonium nitrate may be used as an excellent fertilizer for Citrus fruits agriculture and presently in high premium demand, and may also be used as explosive grade ammonium nitrate for mining and munitions. Ammonium nitrate can be concentrated or diluted as necessary for transport and usage to its final destination and intent.

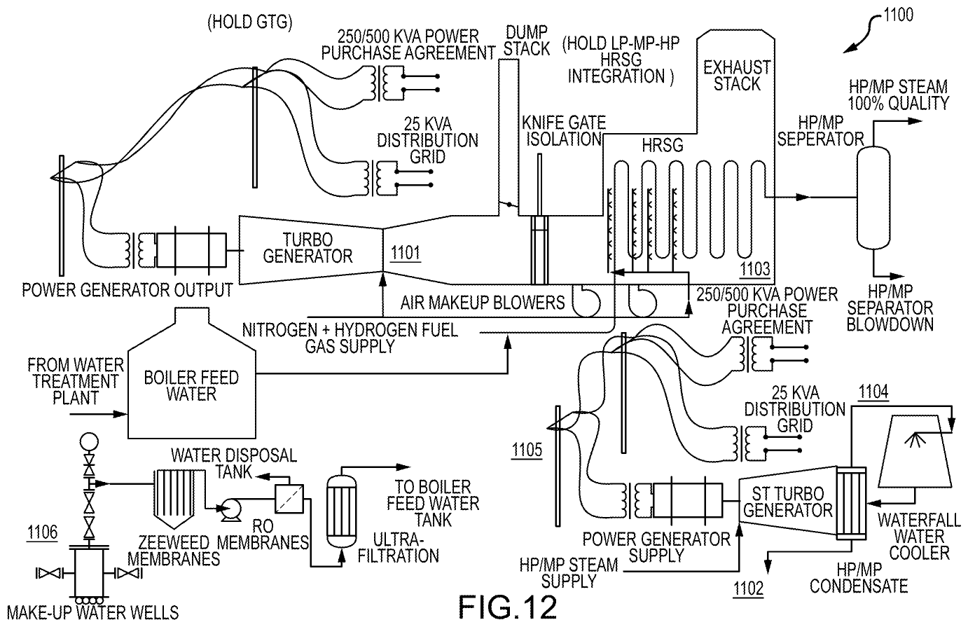

FIG. 12 depicts an example combined heat and power system 1100, according to embodiments of the present disclosure. System 1100 may be integrated into the ammonia production process 10, as described with reference to FIG. 1.

System 1100 may comprise unit 1101 comprising a hydrogen fueled or ammonia fueled gas turbine generator. Unit 1102, depicted in FIG. 12, comprises a condensing steam turbine generator. Unit 1103 comprises a gas turbine generator duct fired on hydrogen fuel heat recovery generator (i.e., H₂ burners installed in the exhaust duct for additional heat and thus steam generation for added power), and unit 1104 comprises a steam condenser with a cooling tower configuration or a chilled water system utilizing the ammonia-water cycle, particularly in areas where water is at a premium because of geographical drought conditions. Unit 1105 comprises an electrical transmission substation integrating generated power from a combined heat and power (CHP) system and combined coolant and power (CCP) system. Unit 1106 comprises an American Society of Mechanical Engineers (ASME), Electrical Power Research Institute (EPRI), or some other quality boiler feed water treatment plant with demineralized water storage.

ASME boiler water quality standards are often hard to achieve. EPRI standards which apply to the power generation, are easier. The conclusion is that in terms of equipment durability there is little to no deference, the claim is both or either/or, the key is equipment durability. Combined heat and power provide the platform to balance steam loads and provide process steam and power.

The ammonia-water cycle presented herein has a major impact in low grade heat recovery and cooling, avoiding the need to consume large amounts of cooling water for steam condensation. Integrating the CHP and CCP cycles provides the great optionality for process cooling and heat, MP and LP steam heating for process heating, and HP and MP with a heat recovery steam generator (HRSG) reheat steam for steam driven equipment and power generation. Process cooling with the CCP avoids complex high volume rates of cooling and achieves elimination of a cooling tower. The cooling water system integration provides for a closed system without air entrainment that results in oxygen corrosion and eliminates cooling water towers with high water evaporation duties and thus conservation of water, particularly in geographical drought prone areas.

The gas turbine generator (GTG) for black start up covering all continuous duty loads allows for the plant to start-up with little to no demand loads from the electrical transmission grid with high voltage motors and great power quality characteristics. The GTG on hydrogen fuel power generated once operational can remain online for power exports of the balance of power.

GTG and STG size and HRSG tube coil configuration may have reheated optionality in order to provide a heat balance with CHP and CCP and maximize efficiency in terms of overall heat, cooling, and power configuration.

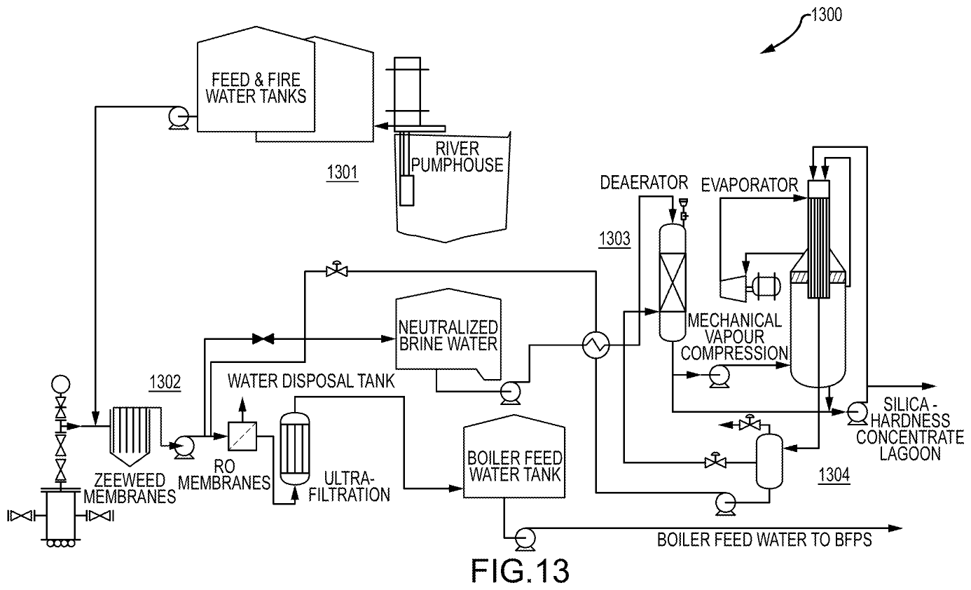

FIG. 13 depicts an example water treatment system 1300, according to embodiments of the present disclosure. System 1300 may be integrated into the ammonia production process 10, as described with reference to FIG. 1.

System 1300 depicts unit 1301 comprising a river pump-house and water storage, unit 1302 comprising reverse osmosis water treatment with ultra-filtration for ASME or EPRI quality boiler feed water treatment and demineralized water storage, and unit 1304 comprising a falling film evaporator with mechanical vapor compression.

A Hydrazine or equivalent oxygen scavenger system may be installed to reduce oxygen in the boiler feed water system.

Depending on the available water quality to be used at the facility, a SAC/WAC water purification system may also be installed to remove access contaminants for the boiler feed water.

Water treatment for the gasifier cooling water quench may also be integrated, however it will require further treatment for chemical oxidation demand (COD).

Additional treatment for chemical loading may also be added for biological treatment of cooling water should an evaporative cooling tower be installed for cooling.

The facility is intended to have a “Zero-Liquid-Discharge” (ZDL) where all the utilized water will be treated and consumed on site.

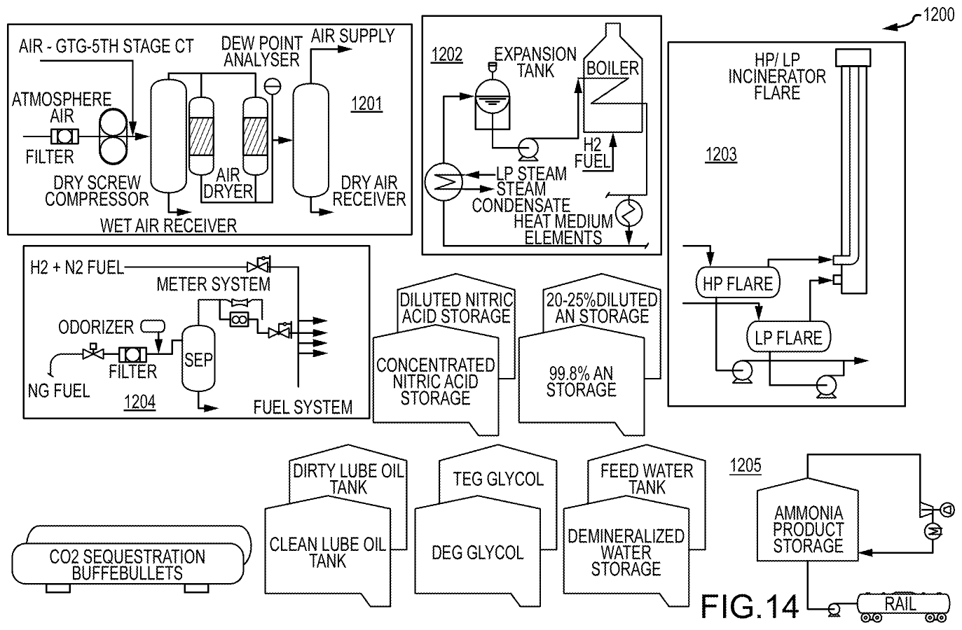

FIG. 14 depicts an example system 1200 comprising utilities and offsites, according to embodiments of the present disclosure. System 1200 may be integrated into the ammonia production process 10, as described with reference to FIG. 1.

System 1200 comprises unit 1201 comprising an instrument air system with a GTG air backup, unit 1202 comprising a heat medium boiler for winterization, and unit 1203 comprising a high pressure oxidizer for pressure safety valve releasing and low pressure for minor vents and drains when the VRU is not operational. In normal operation, the VRU will gather and recycle all combustibles to the gasifier for incineration. If the VRU is not operational, however, all releases or blowdowns from the pressure relief valves for to and incineration stack to combust the vapors so that it does not become a hazard to life and the environment. If the pressure on the system is greater than what the pressure equipment can handle, the pressure will be released and burned into the atmosphere (e.g., during and emergency). Unit 1204, depicted in FIG. 14, comprises a natural gas fuel supply for cold start-up and hydrogen fuel blending with nitrogen as a process fuel source. Unit 1205 comprises product storage and rail/truck loading transload. Options additionally exist for marine loading and transloading from rail or storage.

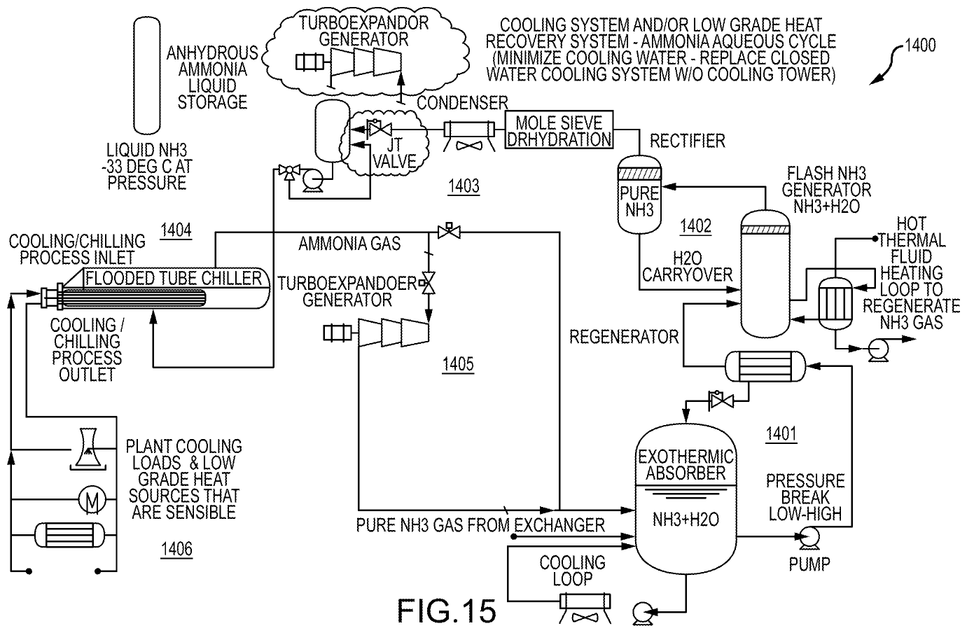

FIG. 15 depicts an example system 1400 comprising ammonia water cycle for combined cooling and power (CCP), according to embodiments of the present disclosure. System 1400 may be integrated into the ammonia production process 10, as described with reference to FIG. 1.

System 1400 comprises a unit 1401 comprising an exothermic water ammonia absorber which dilutes anhydrous ammonia into hydrous ammonia concentrate. Unit 1402 depicted in FIG. 15 comprises an ammonia gas regenerator, which flashes the anhydrous ammonia from the hydrous ammonia solution to about or near 100% anhydrous ammonia. Unit 1403 comprises a mole sieve gas dryer. For small systems, a Joules Thomson valve for liquefaction of the anhydrous ammonia is used. For large systems, a turbo-expander is used for energy efficiency into power additional generation. Unit 1404 comprises a flooded tube chiller to cool fluid heat sources converting cryogenic liquid ammonia into ammonia gas, unit 1405 comprises a turbine expander for reducing the ammonia gas temperature to a level that can be reacted with water to form aqueous ammonia, and unit 1406 comprises process cooling loads and/or low-grade waste heat recovery for the ammonia-water cycle for power generation or simply plant cooling.

System 1400 utilizes ammonia from system 700 as a refrigerant to continuously cool water that can be used as cooling water (CW) throughout the process 10. The CW may then increase in temperature and come back to system 1400 for cooling back to CW. Power can be generated by this water-cooling process and utilized through system 1400 and/or process 10.

Ammonia does not need to be continuously pulled from system 700. Rather, enough ammonia is pulled from system 700 to fill the cycle of system 1400 one time.

Specifically, aqueous ammonia (stored unit 1403, originating from system 700) is utilized in the flooded tube chiller of unit 1404 to cool water. The cooling water is then sent throughout process 10. The ammonia evaporates in the flooded tube chiller and leaves unit 1404 as a gas where it is then directed to a turboexpander generator of unit 1405 to form liquid ammonia. The liquid ammonia comprises a temperature of about 5 to 10 degrees Celsius and a pressure of about 5 to 10 degrees Celsius and enters the exothermic absorber of unit 1401. The ammonia contacts water (from unit 1402) and the ammonia water mixture is then pumped to a higher pressure before entering unit 1402. Hot thermal fluids (e.g., waste heat stream(s) from process 10 and or the heated water entering system 1400) can be used to regenerate (i.e., flash) the ammonia. The ammonia and/or generator of unit 1402 comprises a temperature between about 150 to 200 degrees Celsius and a pressure between about 300 to 600 psi. The water that is separated from the ammonia is directed back to unit 1401. The ammonia leaves unit 1402 and is directed to unit 1403 where it is dried and liquified before flooding the flooded tube chiller of 1404, and so on.

It should be noted that the methods described herein describe possible implementations, and that the operations and the steps may be rearranged or otherwise modified and that other implementations are possible. Further, aspects from two or more of the methods may be combined.

The present disclosure provides aspects for producing an emulsified slurry fuel feedstock applied for feeding a gasification process with high carbon fuel slurry emulsion comprising coal, pet-coke, slop refinery residue, asphaltenes, biomass and other high calorific value streams and/or a mix of them.

Aspects are provided for the manufacture of clean hydrogen fuel for sale and/or to fuel the processes described herein and integrating a clean syngas ammonia synthesis, and ammonium sulfate manufacturing through the combustion of hydrogen sulfide and molten sulfur, capturing sulfur dioxide emissions with up to near 100% (e.g., 99.998%) capture efficiency.

Ammonium sulfate, nitric acid, and ammonium nitrate synthesis described herein may be integrated as described herein with solids gasification, sour water gas shift (SWGS) procedures, carbon and hydrogen sulfide methanol solvent capture of sour gases, combined heat and power (CHP) procedures, and the ammonia-water cycle combined with coolant and power (CCP) procedures as presented herein.

Aspects of the present disclosure provide for a PSA with carbon dioxide liquefaction using an ASU nitrogen refrigerant for hydrogen purity of about 100% (e.g., 99.9999%). Additionally, the combined liquefaction capture process captures carbon dioxide (e.g., at least about 10% to 15%) from PSA regeneration tail gases, and the methanol capture process capture carbon dioxide (85% to 90%) into a dense phase. the captures carbon dioxide may be utilized as a chemical feedstock and/or for deep saline aquifer disposal and sequestration or for enhanced oil recovery EOR. The present discourse achieves about 100% (e.g., 99.9%) carbon capture and about 100% (e.g., 99.998%) sulfur dioxide captured into ammonium sulfate product.

Aspects of the present disclosure support cryogenic temperature gases (e.g., nitrogen) from an ASU being used as a refrigerant for ammonia liquefaction in an ammonia synthesis process, voiding the need for a separate propane and/or ammonia compression refrigeration cycle for ammonia liquefaction.

Aspects of the present disclosure support utilizing the CCP ammonia-water cycle for cooling and power, that is, as a closed cooling cycle in-lieu of evaporative cooling water towers, for process cooling and/or as a closed loop chilled water system, voiding the need for a cooling water tower, particularly in geographical areas where cooling water is scarce or unavailable. Therefore, process water needs are significantly reduced. The ammonia-water cycle as disclosed herein allows for a low-grade heat recovery process, vaporizing ammonia liquid into ammonia gas, expanding the gas through a turboexpander for power and converting the anhydrous ammonia to hydrous ammonia, which significantly reduces the capex and opex associated with traditional refrigeration compression and uses pressure and the exothermic reactions from anhydrous ammonia to hydrous ammonia.

Aspects of the present disclosure support the manufacture of hydrogen, and hydrogen derivatives (e.g., ammonia, ammonia sulfate, nitric acid, ammonium nitrate) from solid fuel feedstock and applies to other manufactured hydrogen derivatives such as ammonia and ammonia derivatives like ammonium sulfates, ammonium nitrates, nitric acid, and other petrochemicals.

Aspects of the present disclosure support the utilization of a flooded tube chiller for carbon dioxide liquefaction with a propane, ammonia or other compression refrigeration cycles, and the ammonia-water cycle as presented herein and in a blue hydrogen and blue ammonia manufacturing and synthesis processes using coal, pet-coke, slop refinery residue, asphaltenes, biomass and other high calorific value streams as fuel.

Aspects of the present disclosure support the utilization of the cryogenic temperature gases (e.g., helium and nitrogen) from an ASU as a refrigerant for hydrogen liquefaction in a blue hydrogen synthesis process. Aspects support the utilization of a VPSA or PSA integrated with compression-mole sieve dryer and liquefaction capture process as described herein.

Aspects of the present disclosure support generating green and/or renewable hydrogen and ammonia where oxygen is used in oxy-combustion or partial oxy-combustion for petrochemicals, alcohols, fuels, and fuel additives from renewable energy sources.

Aspects of the present disclosure support the configuration and utilization of refrigerant cycles described herein and the refrigerant capacity of an integrated ASU in a carbon capture process associated with syngas from a solid gasifier with carbonyl hydrolysis, SWGS as configured and integrated together with VPSA-compression-membranes and liquefaction of carbon dioxide as an industrial and/or petrochemical carbon capture process for the manufacture of blue hydrogen as a fuel and as a feedstock for ammonia petrochemicals and other petrochemical processes.

Aspects of the present disclosure support the configuration and utilization of the capture of hydrogen sulfide through a methanol and amine process to manufacture an ammonium sulfate (AS) fertilizer through direct combustion of hydrogen sulfide and sulfur to generate a sulfur dioxide feed stream to manufacture ammonium sulfate into a solid granulated product as described and detailed herein.

The foregoing discussion has been presented for purposes of illustration and description. The foregoing is not intended to limit the disclosure to the form or forms disclosed herein. In the foregoing Detailed Description, for example, various features are grouped together in one or more embodiments for the purpose of streamlining the disclosure. The features of the embodiments may be combined in alternate embodiments other than those discussed above. This method of disclosure is not to be interpreted as reflecting an intention that the claims require more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate embodiment.

Moreover, though the present disclosure has included description of one or more embodiments and certain variations and modifications, other variations, combinations, and modifications are within the scope of the disclosure, e.g. as may be within the skill and knowledge of those in the art, after understanding the present disclosure. It is intended to obtain rights which include alternative embodiments to the extent permitted, including alternate, interchangeable, and/or equivalent structures, functions, ranges, or steps to those claimed, regardless of whether such alternate, interchangeable, and/or equivalent structures, functions, ranges, or steps are disclosed herein, and without intending to publicly dedicate any patentable subject matter.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “means” shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein. By way of example, the phrase from about 2 to about 4 includes the whole number and/or integer ranges from about 2 to about 3, from about 3 to about 4 and each possible range based on real (e.g., irrational and/or rational) numbers, such as from about 2.1 to about 4.9, from about 2.1 to about 3.4, and so on.

1. A method comprising:
contacting coal, petcoke, or both with water to form a fuel slurry;
contacting one or more surfactant polymers with water to form a surfactant slurry;
mixing the fuel slurry and the surfactant slurry to form a fuel emulsion; and
providing the fuel emulsion to a gasifier to produce a synthesis gas comprising carbon monoxide, carbon dioxide, and sulfur.

2. The method of claim 1, comprising:
mixing the fuel slurry and the surfactant slurry with waste residues to form the fuel emulsion, the waste residues comprising slop refinery residue, asphaltenes, biomass, other high calorific value waste products, or a combination thereof.

3. The method of claim 1, comprising:
converting the carbon monoxide in the synthesis gas to hydrogen and additional carbon dioxide, forming a shifted synthesis gas.

4. The method of claim 3, comprising:
removing at least a portion of the carbon dioxide and hydrogen sulfide in the shifted synthesis gas to form a cleaned synthesis gas, and
capturing the carbon dioxide and hydrogen sulfide removed from the shifted synthesis gas.

5. The method of claim 4, comprising:
removing remaining impurities from the cleaned synthesis gas to form hydrogen gas by inputting the cleaned synthesis gas to a pressure swing adsorption system, the impurities comprising noble gases, oxygen, nitrogen, carbon dioxide, carbon monoxide, or combinations thereof, and
contacting the hydrogen gas with nitrogen to form a gas blend, wherein the gas blend comprises a 3:1 hydrogen to nitrogen ratio.

6. The method of claim 5, comprising:
compressing the gas blend;
passing the gas blend through one or more heat exchangers; and
directing the gas blend from the one or more heat exchangers to an ammonia synthesis reactor to form ammonia from the gas blend.

7. The method of claim 6, comprising:
producing ammonia sulfate, nitric acid, ammonium nitrate, or a combination thereof from the ammonia.

8. The method of claim 6, comprising:
contacting the hydrogen sulfide removed from the shifted synthesis gas with molten sulfur to form sulfur dioxide; and
contacting the sulfur dioxide and ammonia in an aqueous ammonia wash reactor to form ammonia sulfate.

9. A method, comprising:
removing impurities from a synthesis gas by inputting the synthesis gas into a pressure swing adsorber to form a substantially pure hydrogen gas, wherein the impurities comprise noble gases, oxygen, nitrogen, carbon dioxide, carbon monoxide, or combinations thereof,
contacting the hydrogen gas with nitrogen to form a hydrogen and nitrogen gas blend, wherein the gas blend comprises a hydrogen to nitrogen, wherein the gas blend comprises a 3:1 hydrogen to nitrogen ratio; and
producing ammonia from the gas blend.

10. The method of claim 9, comprising:
utilizing a portion of the hydrogen gas for fuel.

11. The method of claim 9, comprising:
removing hydrogen sulfide, or sulfur, or both, from the hydrogen gas by passing the hydrogen gas through a desulfurization bed, wherein the desulfurized hydrogen gas is contacted with the nitrogen to form the hydrogen and nitrogen gas blend.

12. A method, comprising:
contacting hydrogen sulfide gas with ionized molten sulfur in a combustor furnace to form sulfur dioxide; and
contacting sulfur dioxide and aqueous ammonia in an aqueous ammonia wash reactor to form ammonia sulfate.

13. The method of claim 12, comprising:
removing sulfur ash from the sulfur dioxide by passing the sulfur dioxide through a baghouse, wherein the sulfur-ash free sulfur dioxide is contacted with the aqueous ammonia in the absorber.

14. The method of claim 12, wherein the ammonia sulfate is in a crystal form slurried with water, the method of claim 12 further comprising:
drying the ammonia sulfate crystals.

15. A method, comprising:
inputting water into a flooded tube chiller filled with liquid ammonia to form cooled water, wherein the liquid ammonia evaporates into an ammonia gas;
generating a lower pressure ammonia by superheating the ammonia gas at a near constant pressure and expanding the ammonia gas through a turboexpander;
contacting the lower pressure ammonia with water in an exothermic absorber to form an ammonia water mixture at pressure and temperature;
pumping the ammonia water mixture from the exothermic absorber to form a higher pressure ammonia prior to entering into an ammonia regenerator, and
inputting the higher pressure ammonia gas, output from the ammonia regenerator, through a turboexpander to form liquid ammonia for use in the flooded tube chiller.

16. The method of claim 15, comprising:
utilizing the cooled water in a closed loop system to cool one or more system processes that require cooling.

17. The method of claim 15, wherein electric power is generated and recovered from the turboexpander.

18. The method of claim 15, wherein a Joule Thomson (JT) valve is utilized for startup of the turboexpander.

19. The method of claim 15, wherein process waste heat is exchanged in the ammonia regenerator to boil off the ammonia from the ammonia-water mixture into a high pressure pure ammonia, without boiling the water and forming hot water, the hot water is recycled from the ammonia regenerator to the exothermic absorber.

20. The method of claim 15, further comprising:
inputting the high pressure ammonia gas from the ammonia regenerator to a rectifier to remove at least a portion of the water moisture in the high pressure ammonia gas;
inputting the high pressure ammonia gas, output from the ammonia regenerator, to a molecular sieve dryer to remove all or a majority of the remaining water moisture saturated in the high pressure ammonia gas; and
inputting the high pressure ammonia gas, output from the molecular sieve dryer, to a condenser to cool the high pressure ammonia gas prior to inputting the higher pressure ammonia gas through the turboexpander.

21. The method of claim 15, wherein the high pressure ammonia gas exits the turboexpander as liquid ammonia at pressures and temperatures lower than the pressure and temperature requirements of the flooded tube chiller.

22. A system, comprising:
a feed preparation unit to form a fuel emulsion from a surfactant, coal, petcoke, hydrocarbon oil wastes, and water;
a gasifier to form synthesis gas from the fuel emulsion;
a pressure swing adsorber unit to remove impurities from the synthesis gas and form a hydrogen and nitrogen gas blend;
an ammonia synthesis unit to synthesize ammonia from the hydrogen and nitrogen gas blend;
a cryogenic system to cryogenically capture carbon dioxide from the pressure swing adsorber unit.

23. The system of claim 22, comprising:
a water gas shift unit that receives the synthesis gas from the gasifier and converts carbon monoxide to hydrogen to form shifted synthesis gas.

24. The system of claim 23, comprising:
a sour gas capture unit that receives the shifted synthesis gas from the water gas shift unit and captures carbon dioxide and hydrogen sulfide to form a cleaned synthesis gas, wherein the cleaned synthesis gas is input to the pressure swing adsorber unit.

25. The system of claim 24, comprising:
an aqueous ammonia wash reactor, wherein sulfur dioxide is contacted with the ammonia to form ammonia sulfate.

26. The system of claim 24, comprising:
a flooded tube chiller for cooling water via liquid ammonia, forming cooling water and ammonia gas;
a turboexpander to expand the ammonia gas and generate electric power;
an exothermic absorber, wherein the ammonia gas is contacted with water to form aqueous ammonia;
a flash ammonia generator to form a higher pressure ammonia gas;
a liquefying unit to liquefy the second ammonia gas for use as a coolant in the flooded tube chiller, wherein the liquefying unit comprises a condenser, a turboexpander generator, and a Joule-Thompson valve.
